(19) United States
(12) Patent Application Publication
(10) Pub. No.: US 2026/0348659 A1
(43) Pub. Date: Nov. 5, 2026

(54) HEAT PUMP DEVICE FOR ENERGY-EFFICIENT GENERATION OF A PROCESS HEAT, DRYER DEVICE FOR DRYING MATERIAL TO BE DRIED, AND METHOD FOR OPERATING A HEAT PUMP DEVICE

(71) Applicant: LUEBBERS FTS GMBH, BAD LANGENSALZA (DE)

(72) Inventor: Bernd FEUERRIEGEL, BERLIN (DE)

(73) Assignee: LUEBBERS FTS GMBH, BAD LANGENSALZA (DE)

(21) Appl. No.: 19/120,260

(22) PCT Filed: Oct. 6, 2023
(86) PCT No.: PCT/DE2023/200208

§ 371 Date: Apr. 11, 2025

(30) Foreign Application Priority Data
Oct. 14, 2022 (DE) 10 2022 127 011.4

(51) Int. Cl. F26B 23/04; F25B 1/10; F25B 43/00; F25B 49/02

(52) U.S. Cl. CPC F26B 23/04; F25B 1/10; F25B 43/006; F25B 49/02; F25B 2400/23; F25B 2400/27

(57) ABSTRACT

A heat pump device includes an evaporator, a heat exchanger, a heat sink, a heat source, a liquid cyclical process fluid (CPF), a first compressor downstream of the evaporator, a mixing separator, and a second compressor downstream of the mixing separator. The evaporator heats and evaporates the liquid CPF to a vaporous CPF. The first compressor compresses the vaporous CPF to a second pressure stage. The second compressor compresses the vaporous CPF to a first pressure stage. The heat exchanger transfers process heat from the vaporous CPF of the first pressure stage to the heat sink. The heat exchanger condenses the vaporous CPF to condensed CPF. The second connection feeds condensed CPF back into the mixing separator of the second pressure stage. The first connection feeds the vaporous CPF from the first compressor into the mixing separator. Emerging condensed CPF is fed into the evaporator and/or to the second compressor.

### CROSS REFERENCE TO PRIOR APPLICATIONS

This application is a U.S. National Phase application under 35 U.S.C. § 371 of International Application No. PCT/DE2023/200208, filed on Oct. 6, 2023 and which claims benefit to German Patent Application No. 10 2022 127 011.4, filed on Oct. 14, 2022. The International Application was published in German on Apr. 18, 2024 as WO 2024/078669 A1 under PCT Article 21(2).

### FIELD

The present invention relates to a heat pump device for the energy-efficient generation of a process heat, wherein the heat pump device has a heat-absorbing side, a heat-emitting side, a cyclical process fluid and an evaporator on the heat-absorbing side, and the heat pump device can be assigned a heat exchanger and at least one heat sink on the heat-emitting side and at least one heat source on the heat-absorbing side, wherein a liquid cyclical process fluid can be indirectly heated via the evaporator by supplying heat from the assignable heat source and can be evaporated at a pressure stage of the evaporator, and the heat pump device has at least one first compressor downstream of the evaporator, wherein vaporous cyclical process fluid can be compressed from the pressure stage of the evaporator to a second pressure stage via the at least first compressor. The present invention also relates to a dryer device for drying material to be dried via a heated process gas stream and to a method for operating a heat pump device.

### BACKGROUND

In the course of the energy transition and due to the current crisis in natural gas supply, heat pump processes are moving into the focus of process heat generation. While heat is emitted at a low temperature level for domestic heating, industrial heating processes often require significantly higher temperatures. Industrial drying processes require large amounts of heat, for example, sometimes several MW at high temperatures of well over 100 °C, often over 200 °C, and represent one of the largest emitters of greenhouse gases in the industrial sector because the high temperatures are usually generated by combustion processes of solid, liquid or gaseous carbon-based fuels.

When generating process heat using combustion processes or electrically operated heaters, a primary energy input is required that is roughly equivalent to the process heat output to be generated. In order to decarbonize industry, the primary energy used to generate process heat can and should therefore be drastically reduced by replacing the combustion processes previously required to reach temperatures above 120 °C to over 200 °C with suitable, highly efficient high-temperature heat pumps with electric drives to the extent possible.

Heat pump processes for generating process heat can generally be characterized by the heating coefficient of performance COPₕ as a quotient of the heat output in relation to the drive power, the required temperatures of the heat-absorbing side, the achievable temperatures of the heat-emitting side, and the resulting temperature rise between heat absorption and heat output. The development of economical high-temperature heat pumps with a heat output above, for example, 200 °C, has to date failed because the temperature rise is too low, as thermodynamic relationships in the cycle mean that the heating coefficient of performance falls as the temperature rise increases. High heat source temperatures have therefore to date been required on the heat-absorbing side for the operation of known circular processes, which in themselves already represent high-quality heat sources with a correspondingly uneconomically high price or which are not even available as waste heat sources, but would have to be manufactured.

The value of process heat is usually measured according to its temperature level. In a heat pump cyclical process, the temperature level of the process heat emitted is typically achieved by compressing the cyclical process fluid. The specific drive work for compression corresponds to the expenditure, i.e., the destruction, of specific exergy. The amount of specific exergy destruction in turn correlates with the minimum compression pressure that must be applied in order for the cyclical process fluid to reach the required temperature so that process heat can be transferred at the highest sink temperature.

The higher the highest sink temperature required to transfer process heat, the more specific exergy is destroyed, and the higher the value of the process heat generated. Less specific exergy destruction is accordingly required to generate lower-grade process heat than for higher-grade process heat.

Heat pump processes can generally be divided into cyclical processes without phase transition of a cyclical process gas and those with phase transition of a cyclical process fluid from liquid to gaseous in an evaporator on the heat-absorbing side, the phase transition from gaseous to liquid of which takes place either by condensation in a condenser or by transcritical cooling in gas coolers.

Known high-temperature heat pumps without phase transition of the always gaseous cycle process gas, such as rotary heat pumps from the Austrian company ecop Technologies GmbH from AT-4531 Neuhofen an der Krems (www.ecop.at), which are based on a left-running Joule process, can heat sink temperatures of 150 °C with relatively high heating coefficients of performance of around 4, but only achieve a very low temperature rise of around 55K and are limited in their maximum heat output per heat pump due to their design. A multi-stage arrangement of such heat pumps to overcome an overall higher temperature rise is in principle possible, but fails due to significantly higher drive power with constant heat output due to significantly reduced heating coefficients of performance and the associated low economic efficiency as well as the design-related limitation of the heat output that can be absorbed and emitted.

In heat pump cyclical processes with a phase transition of the cyclical process fluid by evaporation, a distinction is made between heat pumps with condensation of the cyclical process fluid on the heat-emitting side and transcritically operated heat pumps with heat dissipation of the cyclical process fluid in gas coolers at supercritical pressure, for example, with carbon dioxide (CO₂) as the cyclical process fluid. The main difference between the two types of cyclical process with phase transition of the cyclical process fluid is that transcritically operated heat pumps transfer the heat output over an extended temperature range and not on a fixed temperature plateau, as is the case with condensing operation.

In the recent past, transcritically operated CO₂ heat pumps have already been built up to sink temperatures of around 120 °C, as described, for example, in EP 2 321 589 B1. In the case of transcritically operated heat pumps, no condensation pressure can be achieved because no actual condensation takes place in a condenser. A correspondingly high compression pressure to a pressure above the critical point of the cyclical process fluid must nevertheless be achieved for heat transfer in a gas cooler from the supercritical cyclical process fluid to the heat sink to be supplied with the highest temperature by applying mechanical work for compression up to the corresponding supercritical pressure of the heat-emitting side.

One advantage of transcritically operated heat pumps with supercritically operated gas coolers is that the cyclical process fluid in the gas cooler can only cool down to a maximum temperature above the inlet temperature of the heat sink and then still has some of its specific heat, which may still be sufficient to supply process heat to lower-grade heat sinks. Although this requires mechanical work to exceed the highest sink temperature, no additional mechanical compression would be required for the subsequent supply of a lower-grade heat sink.

This advantage of transcritically operated heat pumps is, however, also a considerable disadvantage because the successive cooling of the supercritical cyclical process fluid by heat transfer in the gas cooler requires that the respective heat sink still receives sufficient process heat despite this successive temperature loss of the cyclical process fluid, as the inlet and outlet temperatures of the respective heat sink must be sufficiently low for this to occur. If this is not the case and the lowest sink temperature is still too high to cool the supercritical cyclical process fluid to temperatures far enough below the critical point, the transcritical process becomes uneconomical or even impossible, as the evaporator on the heat-absorbing low-pressure side of the transcritical cyclical process can then often not be operated correctly.

Another significant disadvantage of transcritically operated heat pumps with the refrigerant CO₂ for the goal of being able to supply sink temperatures of well over 120 °C with process heat is the high compression pressures of then well over 120 bar in combination with the high CO₂ outlet temperature of well over 130 °C, which presents the design of the forced oil-lubricated piston or screw compressors with previously unsolved technical problems in terms of material strength and temperature resistance of the oil. The mere fact that the compressors must be oil-lubricated because the frictional forces at the high pressures are far too high for oil-free compression requires a functioning oil management system to provide that the effectiveness of downstream units, such as gas coolers and evaporators, is not impaired by the oil content carried in the cyclical process fluid.

An additional disadvantage of known heat pumps with refrigerants such as CO₂, NH₃ and hydrocarbons is their limitation in heating on the heat-absorbing side of heat sources well above 30-40 °C. If this is technically possible, the technically achievable temperature rise is so low that no high temperature for process heat transfer to a heat sink of over 200 °C can be achieved on the heat-emitting side.

In a heat pump cyclical process with condensation of the cyclical process fluid, the condensation temperature to be produced for heat transfer must be sufficiently higher than the temperature of the heat sink to be supplied with the highest sink temperature. The highest required sink temperature and the selection of the cyclical process fluid with regard to its pressure-dependent condensation temperature therefore determine the required pressure in the condenser, i.e., the heat exchanger of the heat sink in which heat dissipation of the heat pump cyclical process takes place, wherein the condensation pressure must usually be achieved by compressing the cyclical process fluid via mechanical work, i.e., the destruction of exergy.

The current development of new heat pumps with condensation of a cyclical process fluid has been focused for some time on the investigation of suitable cyclical process fluids with regard to achieving the highest possible condensation temperature at the lowest possible condensation pressure on the heat-emitting side and at the same time a high evaporation pressure at the lowest possible evaporation temperature on the heat-absorbing side.

Many fluids suitable as cyclical process fluids, also known as refrigerants, which come as close as possible to these properties, however, generally have very poor environmental compatibility in terms of climate damage, ozone depletion, flammability or toxicity. Natural refrigerants such as CO₂, NH₃ and less harmful but flammable hydrocarbons are therefore increasingly being used. It should be noted, however, that virtually all refrigerants currently still authorized by the EU Commission are subject to severe to very severe restrictions with regard to the maximum sink temperature and the achievable temperature rise.

These include, for example, industrial heat pumps with the natural refrigerant NH₃, which are usually operated with condensation of the cyclical process fluid and were already referred to as high-temperature heat pumps in the past when the maximum possible sink temperature was, for example, 80-90 °C. This is due to the critical point of NH₃, which is at 132.35 °C and 113.53 bar, which means that temperatures of 80-90 °C are already just below the critical point. At 200 °C, NH₃ is therefore already supercritical and would no longer be condensable, but could only be used in a transcritical process under very high pressures.

Due to the relatively low critical point of NH₃, a pressure of over 62.55 bar must be overcome for its condensation at, for example, 100 °C. This high pressure level requires high specific compressor work and increases the operating costs for compression. It also makes both the design of oil-lubricated compressors and the design of heat exchangers complex and expensive. The specific condensation enthalpy of NH₃ at 100 °C is furthermore only 715.7 kJ/kg, which means that the resulting heating coefficient of performance is an uneconomically low level. A temperature level of 100 °C is also not sufficient for many industrial processes.

The critical point for CO₂ is even lower, namely, at 31.06 °C and 73.83 bar, so that CO₂ is no longer condensable above 31.06 °C outside the two-phase region, but can only be used for heat transfer in a transcritical process above the critical pressure. Due to the high pressures to be applied, similarly strict restrictions apply to the design and operation as for with NH₃.

The aforementioned cyclical process fluids are gaseous under standard conditions and are very suitable for generating process cooling due to high vapor pressures, for example, at 0 °C at 34.85 bar for CO₂ and at 4.29 bar for NH₃, which emphasizes their good suitability as refrigerants. Both fluids benefit from their relatively low specific volume, for example, at an evaporation temperature of 54 °C, which is 57 l/kg for NH₃ and 5.6 l/kg for CO₂. This enables relatively small apparatus sizes even with high evaporation capacities. In the supercritical range, the specific volumes of both fluids are even below 10-20 l/kg, which is advantageous for the sizes of heat exchangers, but the high supercritical pressure here again comes into play, which makes the construction of apparatus complex.

The use of water vapor as a cyclical process fluid is already known, in particular in power plant technology as a right-running power process for generating electricity, while electrically driven heat pumps with water vapor as a cyclical process fluid in a left-running working process have not yet been named as such. When so-called water heat pumps are currently discussed, however, this usually refers to heat pumps that heat a water flow at least on the heat-emitting side and possibly also cool a water flow on the heat-absorbing side, but the cyclical process fluid of which is not water, but another fluid.

Widely known as a type of heat pump, but not usually constructed in the form of a conventional cycle process, the compression of water vapor, for example, via frequently used vapor recompression, is used to raise the condensation temperature of water vapor in order to make it available for heat transfer at an often slightly higher temperature level, as is the case, for example, with modern evaporation processes with mechanical vapor recompression. With a low temperature rise of a few Kelvin, a very high calculated heating coefficient of performance is achieved, some of which are well above 20. This is, however, a misleading assessment, as it is not a left-running cyclical process typical of heat pumps, which is materially closed. A higher temperature rise of more than 10-20 Kelvin in any case generally requires a multi-stage design, which significantly reduces the total achievable heating coefficient of performance.

Compressors for water vapor are built in various designs as flow machines, for example, in the form of radial blowers for low compression rates below 2 and high volume flows at low final pressures below 5 bar or as turbo compressors for medium compression rates up to around 3 and higher final pressures up to around 20 bar, as well as positive displacement machines in the form of rotary piston compressors for high volume flows at medium compression rates or piston machines for high compression rates up to 6 and particularly high final pressures up to over 70 bar.

The company Spilling Technologies GmbH in Hamburg (www.spilling.de), for example, describes such piston vapor compressors for high outlet pressures of up to 70 bar; however, due to their design, they generally cannot draw in vacuum vapor below 100 °C, but only vapor well above atmospheric pressure. These piston vapor compressors are now even manufactured without oil lubrication of the pistons up to a pressure level of around 40 bar in one design and limited to a steam temperature of around 250 °C. To achieve this, a defined volume of water is injected into the intake vapor stream before it enters the cylinders to reduce superheating in the compressor, so that supersaturated wet vapor with a vapor component xD and a liquid component (1−xD) is produced before compression, wherein the liquid component provides sufficient lubrication of the pistons during compression and evaporates due to the temperature increase during polytropic compression, so that ideally saturated vapor without significant superheating is present at the outlet of the compressor.

The company Piller Blowers & Compressors GmbH in Moringen (www.piller.de) describes vapor compressors in a fan design which are used for vapor recompression in the vacuum range and are currently built for outlet pressures of up to 5 bar overpressure. These are connected in series in several stages to achieve a higher temperature rise. Due to the temperature-dependent material strength of the compressor impellers, the high circumferential speeds required for compression make it necessary to inject a defined quantity of water into the intake vapor stream for cooling before it enters the compressor impeller.

The company Boldrocchi Group S.r.l. in Biassono, Italy (www.boldrocchigroup.com) also describes vapor blowers and turbo compressors in a fan design for compression ratios between around 1.2-3.0 and final pressures of up to 100 bar as well as multi-stage arrangements for different compressors to achieve a higher temperature rise. The Boldrocchi Group also describes the supersaturation of vapor with injected water before it enters the compressor impeller to reduce superheating in the compressor.

The advantage of wet vapor compression lies in the continuous cooling during compression due to the vaporizing liquid component. Compression also takes place at lower overall temperatures due to compensated superheating than would be the case with dry, superheated vapor, as a result of which the specific volume during wet vapor compression is lower compared to uncooled compression of dry vapor in the superheating area, which reduces the size of the compressors for the same mass flow.

One disadvantage of compressing wet vapor is, however, that in addition to the mass flow of the vaporous vapor component x_{D}, the mass flow of liquid water (1−x_{D}) injected before compression, which evaporates during compression, must also be accelerated to the high circumferential speed in the compressor impeller and compressed to the outlet pressure. This water component of the wet vapor, which evaporates into saturated vapor within the compressor impeller, also experiences an increase in its specific volume by a three-digit factor and a corresponding acceleration due to the increasing volume flow, which leads to a higher specific drive torque in relation to the mass flow.

A further disadvantage is that the water content of the wet vapor enters the compressor impeller in liquid form and hits the impeller structure as droplets, which leads to greater mechanical stress on the surfaces and higher fluid friction within the compressor impeller.

The injected water must also be treated or at least decalcified to prevent limescale deposits in the compressor.

In particular in a multi-stage compression arrangement for supplying a saturated vapor mass flow at the outlet of the last compressor stage, each of the compressor stages must compress the saturated vapor mass flow leaving the previous stage and also the water mass flow injected into the respective stage, which is required to reduce the superheat.

The combined effect of these disadvantages increases the specific drive power of the compression in relation to the delivered saturated vapor mass flow.

A further significant disadvantage of the known vapor recompression or vapor compression for providing higher-quality vapor using low-temperature waste heat between 60-80 °C, for example, in the form of vacuum vapor, is that the condensed vapor still has a too high temperature when the heat of condensation is transferred to a heat sink with a high sink temperature, i.e., the liquid vapor condensate, to be evaporated again in a materially closed cycle using the same low-temperature waste heat source between 60-80 °C. In addition to the establishment of a materially closed cyclical process, which could be described as a heat pump cyclical process, the known vapor recompression process thus lacks the necessary cooling of the condensed cyclical process fluid to the evaporation temperature of the heat-absorbing low-pressure side.

Industrial processes also often have several heat sinks that need to be supplied with process heat and these are often even at different temperature levels. For a coupled supply of such different heat sinks with a common heat pump process in condensing mode, its design must also be based on the supply of the highest-value heat sink that has the highest required sink temperature.

A typical example of industrial processes with a high process heat requirement of sometimes several megawatts up to a high temperature level of over 200 °C is large-scale drying processes, such as spray drying processes for the production of powders. In such spray drying processes, large flows of used process gas enriched with water vapor generally result in large waste heat outputs, which are of a similar order of magnitude to the heat required for heating the drying process. Due to the nature of the process, however, this waste heat is always generated at a low temperature level, for example, between 60-80 °C.

If heating with process heat is to take place at a high sink temperature of, for example, over 200 °C, conventional heat pumps can then only achieve a high heating coefficient of performance if a corresponding amount of heat is supplied to the heat pump cyclical process on the low-temperature side and the technically achievable temperature range is not less than the difference between the highest required sink temperature and the lowest available temperature level of the low-temperature heat source.

A temperature range of at least 120-140 Kelvin would be required in order to upgrade low-temperature waste heat flows from a temperature level of between 60-80 °C, which is common in the industry, using heat pump technology with an economically viable heating coefficient of performance of well over 2 to, for example, ideally over 3 to 5, and to be able to utilize them as high-quality process heat at a consistently high temperature level of over 200 °C. A heat pump technology that enables such a heat pump cyclical process is not yet available.

DE 10 2013 008 080 A1 describes an arrangement for a cold-heat coupling with a refrigeration circuit and a heat pump circuit as two left-running cold vapor processes, which are thermally connected to each other via a common intermediate pressure tank, wherein the refrigeration circuit has an evaporator for evaporating a refrigerant and thus generating a refrigerating capacity, a refrigeration compressor and a throttle valve and the heat pump circuit has a heat pump compressor for increasing the pressure of the refrigerant vapor, a condenser for liquefying the refrigerant and a heat pump throttle valve for reducing the pressure of the refrigerant to intermediate pressure level.

US 2012/0116594 A1 describes a pump system for temperature management in which a supersonic ejector is used instead of a conventional compressor. In this system, a stream coming from the evaporator is mixed with part of a stream from a compressor in the ejector and fed into a separator. Another stream after the compressor is condensed in a condenser and expanded by an expansion valve to the intermediate conditions of the separator. A liquid phase of the separator expands through an expansion valve to the conditions of the evaporator, at the outlet of which the vapor is sucked in by the ejector.

EP 2 317 251 A1 describes a two-stage compression heat pump circulatory device with NH₃ as the heat transfer medium. A condenser is arranged on the downstream side of an oil separator, followed by a first cooling device, which is connected to an intercooler. The liquid phase from the intercooler is fed into a second cooling unit and an evaporator, and returned to the intercooler via a lower-stage compressor. The vapor phase from the intercooler enters a high-stage compressor connected to the oil separator in order to separate the oil component contained in the gaseous heat transfer medium from the lubricating oil used for the high-stage compressor. The separated lubricating oil is returned to the gas inlet side of the high-stage compressor or the compressor of the lower stage via a return line.

CN 1 13 251 698 A describes a multi-stage compression heat pump system for the recovery of waste heat in power plants with a high-pressure compressor, a medium-pressure compressor and a low-pressure compressor, wherein an evaporator and a gas-liquid separator are arranged on the low-pressure stage upstream of the low-pressure compressor, which conveys into a first intercooler. One outlet of the first intercooler is connected to the medium-pressure compressor, which in turn feeds into a second intercooler. From the second intercooler, the outlet is fed into a condenser via the high-pressure compressor and returned via its outlet and an intermediate liquid storage tank in stages via throttle valves in each of the individual pressure stages.

### SUMMARY

An aspect of the present invention is to improve on the prior art.

In an embodiment, the present invention provides a heat pump device for an energy-efficient generation of a process heat. The heat pump device includes a heat-absorbing side, a heat-emitting side, a liquid cyclical process fluid; an evaporator arranged on the heat-absorbing side, at least one heat exchanger assigned to the heat-emitting side, at least one heat sink assigned to the heat-emitting side, at least one heat source assigned to the heat-absorbing side, at least one first compressor connected downstream of the evaporator, at least one first mixing separator in the second pressure stage, and at least one second compressor connected downstream of the at least one first mixing separator. The evaporator comprises a pressure stage. The evaporator is configured to indirectly heat the liquid cyclical process fluid via heat supplied from the at least one heat source which is assigned to the heat-absorbing side, and to evaporate the so heated liquid cyclical process fluid at the pressure stage of the evaporator to a vaporous cyclical process fluid. The at least one first compressor is configured to compress the vaporous cyclical process fluid from the pressure stage of the evaporator to a second pressure stage. The at least one first mixing separator comprises a first connection for an inlet of the vaporous cyclical process fluid, a second connection for an inlet of a condensed cyclical process fluid, a third connection for an outlet of the vaporous cyclical process fluid, and a fourth connection for an outlet of an emerging condensed cyclical process fluid. The at least one second compressor is configured to compress the vaporous cyclical process fluid emerging from the third connection from the second pressure stage to a first pressure stage. The at least one heat exchanger is configured to indirectly transfer the process heat from the vaporous cyclical process fluid of the first pressure stage to the at least one heat sink. The at least one heat exchanger is configured to condense the vaporous cyclical process fluid to the condensed cyclical process fluid. The second connection is configured and connected to feed back the condensed cyclical process fluid condensed in the at least one heat exchanger into the at least one first mixing separator of the second pressure stage. The first connection is configured and connected to, simultaneously with the feeding back via the second connection of the condensed cyclical process fluid condensed in the at least one heat exchanger into the at least one first mixing separator of the second pressure stage, feed the vaporous cyclical process fluid from the at least one first compressor into the at least one first mixing separator. The fourth connection is configured and connected to feed back the emerging condensed cyclical process fluid directly or indirectly into the evaporator and/or to feed the emerging condensed cyclical process fluid to the at least second compressor.

### BRIEF DESCRIPTION OF THE DRAWINGS

The present invention is described in greater detail below on the basis of embodiments and of the drawings in which:

FIG. 1 shows a highly schematic representation of a heat pump device with an evaporator, a first compressor, a mixing separator of a second pressure stage, a second compressor, and a heat exchanger of a first pressure stage;

FIG. 2 shows a highly schematic representation of an alternative to the heat pump device shown in FIG. 1 with heating of an evaporator via a circuit through a heat exchanger of a heat source;

FIG. 3 shows a highly schematic representation of an alternative to the heat pump device shown in FIG. 2 with an additional mixing separator after compression to a first pressure stage;

FIG. 4 shows a highly schematic representation of an alternative to the heat pump device shown in FIG. 3 and a thermal compressor supplied with motive steam from its first pressure stage for compressing vaporous cyclical process fluid from the pressure stage of the evaporator to a second pressure stage;

FIG. 5 shows a highly schematic representation of an alternative to the heat pump device shown in FIG. 4 and a thermal compressor supplied with motive steam from a motive steam pressure stage for compressing vaporous cyclical process fluid from the pressure stage of the evaporator to a second pressure stage;

FIG. 6 shows a highly schematic representation of an alternative to the heat pump device shown in FIG. 3 with an additional third pressure stage;

FIG. 7 shows a highly schematic representation of an alternative to the heat pump device shown in FIG. 6 with an additional transfer of process heat of a second pressure stage in a heat exchanger of a second heat sink;

FIG. 8 shows a highly schematic representation of a further alternative to the heat pump device shown in FIG. 6 with an additional fourth pressure stage;

FIG. 9 shows a highly schematic representation of an alternative to the heat pump device shown in FIG. 8 with a thermal compressor supplied with motive steam from a motive steam pressure stage for compressing vaporous cyclical process fluid from the pressure stage of the evaporator to a fourth pressure stage;

FIG. 10 shows a highly schematic representation of a further alternative to the heat pump device shown in FIG. 8 with an additional transfer of process heat of a second pressure stage in a heat exchanger of a second heat sink;

FIG. 11 shows a highly schematic representation of an alternative to the heat pump device shown in FIG. 10 with a transfer of process heat of a third instead of a second pressure stage in a heat exchanger of a second heat sink; and

FIG. 12 shows a schematic representation of a mixing separator of a heat pump device.

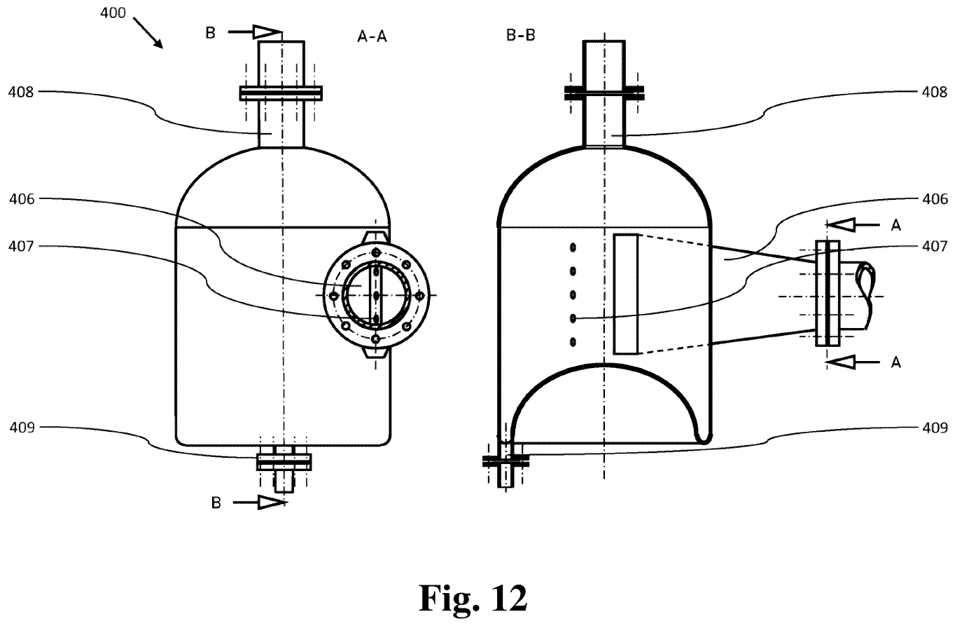

### DETAILED DESCRIPTION

The present invention provides a heat pump device for the energy-efficient generation of a process heat, wherein the heat pump device has a heat-absorbing side, a heat-emitting side, a cyclical process fluid and an evaporator on the heat-absorbing side, and at least one heat exchanger and at least one heat sink can be assigned to the heat-emitting side and at least one heat source can be assigned to the heat pump device on the heat-absorbing side, wherein liquid cyclical process fluid can be indirectly heated via the evaporator by supplying heat from the assignable heat source and can be evaporated at a pressure stage of the evaporator, and the heat pump device has at least one first compressor downstream of the evaporator, wherein vaporous cyclical process fluid can be compressed from the pressure stage of the evaporator to a second pressure stage via the at least first compressor, and the heat pump device has at least one first mixing separator in the second pressure stage, wherein the at least one first mixing separator has a first connection for the inlet of vaporous cyclical process fluid, a second connection for the inlet of condensed cyclical process fluid, a third connection for the outlet of vaporous cyclical process fluid, and optionally a fourth connection for the outlet of condensed cyclical process fluid and at least one second compressor is connected downstream of the mixing separator, so that vaporous cyclical process fluid emerging from the third connection can be compressed in the at least one second compressor from the second pressure stage to a first pressure stage and via the at least one assigned heat exchanger, process heat can be indirectly transferred from the vaporous cyclical process fluid of the first pressure stage to the at least one assignable heat sink and that cyclical process fluid condensed in the at least one heat exchanger can be fed via the second connection back to the at least first mixing separator of the second pressure stage, wherein at the same time vaporous cyclical process fluid from the at least first compressor can be fed into the mixing separator via the first connection, wherein the at least first mixing separator has the fourth connection for the outlet of condensed cyclical process fluid, so that the condensed cycle process fluid that emerges can be fed back directly or indirectly into the evaporator and/or can be fed to the at least second compressor.

A high-temperature heat pump is thus provided in which, when the at least one mixing separator is arranged in the second pressure stage, process heat in a temperature range of approximately 100 °C to 250 °C can be released on the heat-emitting side via the at least one heat exchanger of the first pressure stage.

For this purpose, the fourth connection of the at least first mixing separator can be connected directly or indirectly to the evaporator and/or the at least second compressor via at least one pipe.

It is particularly advantageous that the heat pump device can be operated with, for example, water as a natural and completely environmentally compatible cyclical process fluid.

Water is liquid at standard conditions and has the advantage of a high critical pressure of 221.2 bar and a high critical temperature of 374.15 °C, whereby a high condensation enthalpy of 1,933 kJ/kg can be utilized for heat transfer to a heat sink in the two-phase region at a comparatively low pressure of 16 bar and at a condensation temperature of, for example, already over 201 °C, while in comparison the specific condensation enthalpy of NH₃ at only 100 °C and already 62.55 bar is only 715.7 kJ/kg.

A heat pump device with a heat pump cyclical process is thus provided which is based on a cyclical process with at least three pressure stages with different high pressures, with:
at least one first pressure stage with a pressure of the vaporous cyclical process fluid that corresponds to the highest condensation pressure of the cyclical process fluid in the cyclical process on its heat-emitting side so that the condensation temperature of the cyclical process fluid is so far above the highest required sink temperature of the highest-value heat sink to be supplied that this is sufficient for heat transfer from the condensing cyclical process fluid to the highest-value heat sink; and
at least one second pressure stage, in which the at least one mixing separator is arranged and which has a pressure of the vaporous cyclical process fluid which is lower than that of the first pressure stage and higher than the evaporation pressure of the cyclical process fluid in the evaporator; and
at least one lowest pressure stage with a pressure of the vaporous cyclical process fluid corresponding to the evaporation pressure in the evaporator, which corresponds to the lowest condensation pressure of the cyclical process fluid within the cyclical process of the heat pump device.

An important concept of the present invention is based on the fact that a reduction in the destruction of specific exergy in the total specific compressor work to be expended in relation to the specific usable process heat takes place at the temperature level of the highest required sink temperature in each case. This is achieved by successive enthalpy utilization of condensed cyclical process fluid after its condensation enthalpy at the condensation pressure of a first pressure stage has been made usable as process heat for a heat sink of the highest required sink temperature and enthalpy contained in the condensed cyclical process fluid of this first pressure stage is partially fed to the vaporous cyclical process fluid of at least one second pressure stage in at least one mixing separator in the compression train. When the condensed cyclical process fluid of the first pressure stage passes into the at least one mixing separator of a second, i.e., a lower, pressure stage with a lower condensation temperature, the liquid cyclical process fluid cools down to the condensation temperature of the lower pressure stage and part of its enthalpy is used to evaporate part of the liquid cyclical process fluid. This evaporated portion is added to the already vaporous flow of cyclical process fluid in the compression train at this lower pressure stage without compressor work, thereby increasing the condensation enthalpy of the vaporous cyclical process fluid available at this pressure stage, while the compressor work to be expended up to this pressure stage remains constant. This increases the heating coefficient of performance and improves energy efficiency.

The following terms are explained:

A “heat pump device” is, in particular, a machine that uses technical work to absorb thermal energy from a reservoir and/or a heat source at a low temperature and, together with drive energy, transfers it as useful heat to a system to be heated and/or a heat sink at a higher temperature. A heat pump device is configured in particular to carry out a heat pump cyclical process on a cyclical process fluid with the aim of transferring process heat to a heat sink by absorbing heat from an available heat source at a low temperature and upgrading the absorbed heat by increasing the temperature via mechanical work to at least one highest required sink temperature for the heat sink.

A “heat pump cyclical process” is in particular a cyclical process in which a closed quantity of a cyclical process fluid is compressed to a high pressure, in particular by supplying heat from a reservoir and/or a heat source in a mixing separator, or a combination thereof, and thereby assumes a higher temperature, is then at least cooled or also condensed at this high pressure by removing heat from a heat sink and is then brought back to a low pressure before evaporation, at least by throttling or also removing heat.

A “cyclical process fluid” is, in particular, a fluid that is evaporated at low pressure under certain physical state conditions, subsequently vaporous cyclical process fluid, in particular by performing mechanical work or by other processes, such as mixing with vaporous cyclical process fluid of a higher pressure in a in particular, on the one hand, either liquid, gaseous or both at the same time, wherein the latter is referred to as the two-phase state, which is represented in state diagrams within the two-phase region between the boiling line and the condensation line, or on the other hand supercritical, which describes state conditions outside the two-phase region, i.e., either a pressure higher than the critical pressure of the fluid or a temperature higher than the critical temperature of the fluid. A quantity of liquid or vaporous cyclical process fluid of any pressure stage can also be removed from the cyclical process per unit of time for other thermal or material utilization and the same quantity of liquid or vaporous cyclical process fluid can be fed back into the cyclical process at another point in the same unit of time. This can be vaporous cyclical process fluid, for example, which is used as a heating medium or motive steam for an external process and is fed back into the cyclical process at another point, for example, in liquid form as condensed cyclical process fluid. A withdrawal point can also be realized at which in particular cyclical process fluid is withdrawn sporadically or continuously for cleaning purposes and cleaned cyclical process fluid is reintroduced into the cyclical process at a further feed point in order to check and/or adjust the quality of the cyclical process fluid and its level within the heat pump device.

A “process heat” is in particular a heat transferred to a heat sink by at least one heat exchanger in the first pressure stage or to another heat sink by another heat exchanger in another pressure stage.

A “heat sink” is in particular a reservoir and/or a flow with an inlet and an outlet of a fluid or heat transfer medium, the temperature of which is to be raised from an inlet temperature of the inlet to an outlet temperature of the outlet, wherein the target temperature to be achieved for the outlet temperature of the heat sink is the “highest required sink temperature” of a heat sink. A heat sink can be a heat transfer medium that is heated for the purpose of heating another fluid and/or material flow, in particular in an external device outside the heat pump device so that, for example, a heat transfer medium is heated in a heat exchanger that is used to heat an external process in another device, for example, a dryer or its auxiliary media or its material to be dried. The heat sink can also be a process gas stream that is heated in a drying device for drying a wet material, so that a drying process is subsequently operated with the process gas stream, in that the heated process gas transfers heat to a wet material and thus to a material to be dried, evaporates the moisture contained therein, and possibly also removes it from the material to be dried.

A “heat source” is in particular a reservoir, the temperature of which can be used to transfer heat and/or waste heat to a cyclical process fluid. A heat source can also be a flow with an inlet and an outlet of a fluid or heat transfer medium, the temperature of which can be lowered from a highest available temperature, i.e., the lowest available source temperature, from an inlet temperature of the inlet to an outlet temperature of the outlet, wherein in particular a target temperature for heat transfer in an evaporator is the “lowest possible source temperature” of the outlet of a heat source. A heat source can also be a waste heat stream that is used to heat the evaporator of the heat pump device in order to supply the cyclical process with sufficient heat at low pressures of the cyclical process fluid to provide sufficient process heat in at least one heat exchanger. A heat source may similarly be a process gas stream exiting a drying device after drying a wet material, i.e., waste heat, and the heat content of the process gas stream is utilized for heat recovery via a heat exchanger of the heat source to heat the evaporator of the heat pump device, wherein drying devices may often have a high heat loss via a process gas stream exiting a drying device after drying a wet material, which generally amounts to approximately the process heat requirement of the drying device, but is regularly available at a significantly lower temperature level and therefore potentially usable to heat the evaporator of the heat pump device. A heat source can also be a heat-emitting side, for example, waste heat, of a refrigeration system used to generate process cooling, the emitted heat of which is used to heat the evaporator of the heat pump device. A heat source can also be a heat-emitting side of a refrigeration system or heat pump used to generate process cooling, the heat emitted by which is utilized in a heat exchanger of the heat source to indirectly heat the evaporator of the heat pump device. In refrigeration systems that are often operated intermittently and are therefore subject to fluctuations in heat output, an additional heat supply that is as constant as possible can be provided to heat the evaporator of the heat pump device, in particular to compensate therefor. Such compensation can in particular be realized in the form of a combination of different waste heat flows, for example, waste heat from a process gas flow in combination with waste heat from a refrigeration system or heat pump or with other waste heat.

The term “waste heat” refers in particular to a heat source, the heat of which is available at such a low temperature level that, in particular in the vicinity of the heat source, there is no heat sink with the highest required sink temperature for utilizing this heat as process heat, or if this heat could only be utilized as process heat at an economically unacceptable cost.

A “heating coefficient of performance” with the abbreviation COPₕ is in particular the quotient of usable process heat per unit of time in relation to the mechanical work expended per unit of time and, in particular for a heat pump device, represents a key figure for the energy efficiency of the generation of process heat.

A “heat exchanger” is in particular a device in which thermal energy, i.e., heat, is transferred from a material flow at a higher temperature to another material flow at a lower temperature, wherein the material flows are spatially and materially separated from each other by a wall of the heat exchanger. A heat exchanger can, for example, be an indirect heat exchanger. One of the material flows passing through a heat exchanger can, for example, be the cyclical process fluid or an inlet or outlet of a fluid or heat transfer medium of a heat sink or heat source. The heat pump device can also have two or more heat exchangers on the heat-absorbing side and/or heat-emitting side.

An “evaporator” is in particular a device or apparatus in which a liquid cyclical process fluid changes its state from liquid to gaseous by, in particular, indirect heat transfer from a heat source and thus undergoes a “phase transition” from liquid to gaseous, wherein the gaseous state of a cyclical process fluid is generally referred to as “vapor” and the state form as “vaporous” if it is a cyclical process in which at least one phase transition occurs between two state forms, whereas a gaseous state indicates that no phase transition occurs. An evaporator is in particular arranged in the lowest pressure stage of the cycle.

A “compressor” is in particular a device or apparatus for compressing and/or increasing the pressure of a compressible fluid, for example, a vaporous cyclical process fluid, in particular with the aim of achieving a higher pressure level in order to raise the condensation temperature of the vaporous cyclical process fluid. This is also referred to as “upgrading” the heat content of the vaporous cyclical process fluid for utilization as a “higher-value” process heat. A compressor is in particular designed in the form of a turbomachine, such as an axial fan, a radial fan, a turbo compressor or a turbine. A compressor can also be designed as a positive displacement machine, such as a piston compressor, a rotary piston compressor or a screw compressor. A compressor can be a thermal compressor, such as a vacuum vapor jet pump, in which vaporous cyclical process fluid of a second or first pressure stage is used as motive steam, which reaches high speeds in the thermal compressor and thereby draws in a suction vapor in the form of vaporous cyclical process fluid at a pressure lower than that of the motive vapor, wherein motive steam and suction vapor subsequently mix to form a mixed vapor at the pressure of a pressure stage having a higher pressure than the suction vapor and a lower pressure than the motive steam.

A “compression train” is in particular a sequence of compression processes of vaporous cyclical process fluid in at least two compressors connected directly or indirectly one after the other, regardless of the design, with the aim of compressing the vaporous cyclical process fluid from at least one lower pressure stage to at least one higher pressure stage.

“Superheating” is in particular a state condition of a vaporous cyclical process fluid, the temperature of which is above the condensation temperature that correlates with its prevailing pressure and/or pressure stage and is commonly expressed in simplified terms as a temperature difference in Kelvin. The degree of superheating is in contrast correctly understood as the difference between the specific enthalpy of the vaporous cyclical process fluid and the specific enthalpy of saturated vapor in kJ/kg at the prevailing pressure.

A “pressure stage” is to be understood in particular as a synonym for a total pressure reached in the outlet of a compressor, irrespective of the design, after compression of vaporous cyclical process fluid to indicate that a heat pump device involves the gradual compression of vaporous cyclical process fluid. This is accompanied by the corresponding boiling and condensation temperature of the cyclical process fluid at the pressure of this pressure stage.

A “first pressure stage” is to be understood in particular as the pressure stage with the highest condensation pressure of the cyclical process fluid within the heat pump device, which is required in order to be able to supply the heat sink with the highest required sink temperature with process heat by condensation, for example, in a pressure range between about 1 bar for process heat of about 100 °C to about 40 bar for process heat of about 250 °C.

A “pressure stage of an evaporator” is to be understood in particular as the pressure stage at which an evaporator of the heat pump device is operated in order to evaporate liquid cyclical process fluid with the addition of heat from a heat source, for example, in a pressure range between about 40 hPa at a lowest source temperature of about 30 °C to about 1.4 bar at a lowest source temperature of about 110 °C.

A “second pressure stage” is to be understood in particular as a pressure stage below a first pressure stage and above the pressure stage of an evaporator. The at least one mixing separator is in particular arranged in the second pressure stage.

A “third pressure stage” is to be understood in particular as a pressure stage below a second pressure stage and above the pressure stage of an evaporator. A “fourth pressure stage” is to be understood in particular as a pressure stage below a third pressure stage and above the pressure stage of an evaporator. A “fifth, sixth, seventh and optionally a further pressure stage” is to be understood in particular in the same way. The designation of the pressure stages serves in particular to differentiate the respective pressure present and does not represent a fixed order.

A “mixing separator” is in particular a device, each of which is assigned to a specific pressure stage with a pressure above the pressure stage of an evaporator and less than and/or equal to the first pressure stage, wherein a mixing separator encloses a volume and has at least one connection for the inlet for vaporous cyclical process fluid of the assigned pressure stage, one connection for the inlet for liquid cyclical process fluid and one connection for the outlet for vaporous cyclical process fluid of the assigned pressure stage. One important function of a mixing separator is in particular to saturate a flow of vaporous, superheated cyclical process fluid after compression by mixing it with liquid cyclical process fluid. Another function of a mixing separator can also be the expansion and spontaneous evaporation of liquid cyclical process fluid, for example, from a higher pressure stage, if its temperature is higher than the correlating condensation temperature of the assigned pressure stage of the mixing separator.

The present invention provides that the at least first mixing separator has the fourth connection for the outlet of condensed cyclical process fluid, so that the exiting condensed cyclical process fluid can be returned directly or indirectly to the evaporator and/or fed to the at least second compressor.

The at least the first mixing separator can therefore have the connection for the outlet for liquid cyclical process fluid of the pressure stage assigned to the mixing separator, through which excess liquid cyclical process fluid possibly escapes, which is not required or consumed for the saturation of vaporous cyclical process fluid entering the mixing separator at a connection for the inlet in a superheated state, or which does not evaporate by spontaneous evaporation on entering the mixing separator, and which then exits the mixing separator at the corresponding condensation temperature of the relevant assigned pressure stage of the mixing separator.

The liquid cyclical process fluid emerging from at least the first mixing separator can be returned to the evaporator via a condensate separator. A partial stream of the liquid cyclical process fluid can also be fed to the second compressor via a condensate pump and/or a control valve. The liquid cyclical process fluid emerging from the at least first mixing separator can therefore be used to generate wet vapor.

In order to provide an interface to at least one heat sink, the heat pump device has the at least one heat exchanger assigned to the first pressure stage and/or a heat exchanger assigned to the second pressure stage and/or a heat exchanger assigned to a pressure stage below the second pressure stage on the heat-emitting side.

In a further embodiment of the present invention, the heat pump device can have the at least one heat source and/or the at least one heat sink.

To provide a customizable multi-level, modular structure and to realize a subdivision of the compaction, the heat pump device has a second mixing separator, a third mixing separator, a fourth mixing separator and/or optionally further mixing separators, wherein a further compressor is connected upstream of the respective mixing separator.

Two or more mixing separators can thus be arranged between the evaporator and the first pressure stage, in particular connected in series.

The desired temperature rise between the lowest available heat source and/or waste heat temperature and the highest required sink temperature can be configured variably via a multi-stage design and the subdivision of the compression of the vaporous cyclical process fluid into several compression steps on individual pressure stages, i.e., from the lowest pressure of the cyclical process of a pressure stage in an evaporator to the highest required pressure of the first pressure stage, which build on each other. This reduces the pressure ratio required per compression step, i.e., the quotient of the compression pressure reached in relation to the inlet pressure before compression, which means that the superheating of the compressed cyclical process fluid, conventionally expressed in Kelvin above the condensation temperature at the compression pressure reached, is significantly lower than with single-stage compression from the lowest to the highest pressure in the cyclical process. This allows high final pressures to be achieved which, depending on the selection of the cyclical process fluid and the position of its critical point and two-phase region, enable correspondingly high condensation temperatures and condensation enthalpies for the transfer of process heat to a heat sink. This means that, in particular with water as the cyclical process fluid, condensation conditions are, for example, possible at only 40 bar up to around 250 °C.

Due to the variably scalable heat pump device and the widely configurable design of the heat pump device, the range of applications can be extended to a temperature level of up to 250 °C with a temperature range of almost 200 Kelvin at heating coefficients of performance of over 2.5, while maintaining the utilization of waste heat with temperatures below 60 °C to 80 °C for the generation of process heat, wherein process heat can also be released simultaneously at several different temperature levels between, for example, 100 °C and 250 °C.

This multi-stage design is advantageous for several reasons. Superheating during compression can be reduced, which does not represent a thermal advantage, but can make lubrication of pistons or other sliding surfaces of displacement bodies superfluous, for example, in high-pressure compressors based on the positive displacement principle, thus enabling an oil-free implementation of the compressors and a simplified design, as well as extending the field of application to hygienic vapor.

Branches can be created in the cyclical process that enable the utilization of process heat at different temperature levels by not only generating the highest-value process heat for the highest required sink temperature, but also by specifically supplying heat sinks with a lower required sink temperature with process heat generated for this purpose at a lower condensation temperature of the cyclical process fluid at a second, third, fourth and/or further pressure stage. This reduces the overall destruction of specific exergy, as less specific compression work is required for lower-value process heat than for higher-value process heat. A design with more than three pressure stages and separate generation of process heat of different values at different temperature levels increases the overall heating coefficient of performance of the heat pump process.

This enables the generation of approximately saturated vapor of a highest pressure stage by introducing liquid cyclical process fluid of a lower pressure stage either upstream of the highest compressor, so that it operates as a wet vapor compressor, or downstream of the highest compressor, e.g., if another mixing separator of the highest pressure stage follows. Liquid condensate from any pressure stage of the lower pressure stages (and therefore not only from the lowest stage above the evaporator) can be used to saturate the compressed vapor of the highest pressure stage.

In a further embodiment of the heat pump device of the present invention, one mixing separator or two or more mixing separators are connected upstream of the first mixing separator, wherein the vaporous cyclical process fluid of the respective upstream mixing separator (300, 310) can be fed to the downstream mixing separator (310, 400) via a respective downstream compressor (311, 401) and/or the liquid cyclical process fluid from the respective downstream mixing separator (310, 400) can be fed back to the upstream mixing separator (300, 310) at a higher pressure and/or a higher temperature than in the upstream mixing separator (300, 310).

This provides a heat pump device in which vaporous cyclical process fluid of at least a second, third, fourth and/or further pressure stage condenses in at least one heat exchanger of at least a second heat sink and indirectly transfers heat thereto, wherein a cyclical process fluid condensed at this second, third, fourth and/or further pressure stage in the heat exchanger of a second or further heat sink enters a mixing separator of a respectively lower pressure stage, i.e., a third, fourth, fifth and/or further pressure stage, at a pressure below that of the cyclical process fluid condensing in the heat exchanger.

The heat pump device thus enables an extended heat pump cyclical process based on a circuit process with at least four pressure stages with different pressures, i.e., at least one first, at least one second, at least one third pressure stage and at least one lowest pressure stage of the heat pump circulator process at the pressure of an evaporator, wherein the heat pump device is easily scalable and variably configurable by adding further pressure stages, i.e., a fourth, fifth, sixth and/or subsequent pressure stage with corresponding mixing separators and compressors, in order to adjust the total achievable temperature rise as required.

In the heat pump device with stepwise compression, the vaporous cyclical process fluid is compressed from a mixing separator of one pressure stage to a higher pressure stage in each compression step and is superheated in the process due to polytropic compression. The superheat that is present in the vaporous cyclical process fluid after compression and subsequently after entry into a mixing separator assigned to a pressure stage is used to proportionally vaporize liquid cyclical process fluid that enters the respective mixing separator of the pressure stage achieved by upstream compression via a connection. This evaporated portion is added to the already vaporous flow of cyclical process fluid in the compression train at this pressure stage without compressor work, which increases the total condensation enthalpy of the vaporous cyclical process fluid available later as process heat at this pressure stage, while the compressor work remains constant until then. This increases the heating coefficient of performance.

Another advantage of the heat pump device with gradual compression is the use of cyclical process fluid to reduce the superheating that occurs due to compression, as the cyclical process fluid itself has already been treated once for the initial filling of the heat pump device or at least decalcified and is reused due to the closed cycle, which completely avoids continuous water consumption through the injection of tap water or other water containing limescale and the unavoidable limescale deposits compared to the prior art.

A further advantage of the heat pump device with gradual compression is the gradual cooling of condensed cyclical process fluid to complete the cyclical process by expansion in lower pressure stages with full utilization of the enthalpy obtained therein, wherein the latter is added to the vapor mass flow of the lower pressure stage without compressor work for additional evaporation of liquid cyclical process fluid as an additional saturated vapor component. This increases the heating coefficient of performance again.

Another advantage of the heat pump device with gradual cooling of condensed cyclical process fluid in individual pressure stages is the significantly increasing volume of vaporous cyclical process fluid in the compression train along the pressure rise during gradual compression, which means that considerably less liquid cyclical process fluid must be evaporated in the evaporator than must be provided for condensation to heat heat sinks. Only a significantly lower mass flow rate of vaporous cyclical process fluid must therefore be transported through the evaporator and compressed one after the other in the compressors of the lower pressure stages of the compressor train, which typically have the largest sizes due to the large specific volume of the vaporous cyclical process fluid at low pressure. This significantly reduces the size of these devices without compromising on performance.

To improve the feeding back of the cyclical process fluid condensed in at least one heat exchanger from the first and/or further pressure stage, a condensate separator and/or a condensate separator for returning condensed cyclical process fluid from the first pressure stage to the first mixing separator and/or condensed cyclical process fluid from the second or a third pressure stage to an upstream mixing condenser is or are connected downstream of the at least one heat exchanger, in particular of a lower pressure stage, in particular a lower pressure stage in each case.

In a further embodiment of the heat pump device of the present invention, a condensate separator for feeding the condensed cyclical process fluid back into the respective upstream mixing separator or into the evaporator is or are arranged downstream of the fourth connection for the outlet of condensed cyclical process fluid from the first mixing separator, an upstream mixing separator and/or the respective mixing separator.

In order to generate mixed vapor of one pressure stage and to suck in suction vapor from its lower pressure stage or the pressure stage of the evaporator, the first compressor is designed as a thermal compressor so that the vaporous cyclical process fluid of the first pressure stage can be mixed as motive steam with the vaporous cyclical process fluid from the evaporator as suction vapor via the thermal compressor and can be fed to the first mixing separator or the first upstream mixing separator as compressed mixed steam.

A compressor connected upstream of the mixing separator of the respective pressure stage is accordingly designed as a thermal compressor so that the vaporous cyclical process fluid of a higher pressure stage can be mixed as motive steam with the vaporous cyclical process fluid of a lower pressure stage as suction vapor via the thermal compressor and can be fed to the mixing separator of this pressure stage as compressed mixed vapor.

A stream or partial stream of vaporous cyclical process fluid of a first or a further pressure stage can in particular be used as motive steam in the thermal compressor, which reaches high velocities in the thermal compressor and thus, due to Venturi or Coandă effects, draws in a suction vapor in the form of vaporous cyclical process fluid at a pressure lower than that of the motive steam, wherein motive steam and suction vapor subsequently mix to form a mixed vapor with a pressure of a pressure stage that is higher than the pressure of the suction vapor and lower than the pressure of the motive steam.

In a further embodiment of the heat pump device of the present invention, a further compressor is arranged upstream of the thermal compressor in the first pressure stage or the second pressure stage or a further pressure stage, so that the compressed vaporous cyclical process fluid, in particular the vaporous cyclical process fluid originating from the first pressure stage and further compressed to the pressure of a motive steam pressure stage, can be used as motive steam.

In order to realize wet vapor compression or dry compression, a further mixing separator is connected downstream of the first mixing separator in the second pressure stage, wherein the further mixing separator is arranged in the first pressure stage.

The downstream mixing separator in the first pressure stage can have a downstream compressor or it can be free of a compressor.

In a further embodiment of the present invention, the heat pump device has a control and/or regulating device for controlling and/or regulating components of the heat pump device and optionally the at least one heat source and/or the at least one heat sink.

This makes it possible to control and/or regulate the heat pump device and its process heat supply with regard to the highest possible energy efficiency due to the lowest possible drive power by regulating pressures and temperatures of individual pressure stages by controlling compressors and regulating the heat output of the heat source as well as regulating flows of condensed cyclical process fluid at the inlet to individual mixing separators and/or compressors. This means that at least one sub-process contained in the heat pump device or connected thereto, or even the overall process of the heat pump device, can be controlled and regulated by at least one control and/or regulating device.

To feed the condensed cyclical process fluid back to the respective mixing separator in the form of droplets, the second connection for the inlet of condensed cyclical process fluid has a spraying device for spraying the liquid cyclical process fluid entering the first mixing separator or the respective mixing separator.

The spraying device can, for example, be a spray nozzle. The incoming liquid cyclical process fluid is therefore sprayed into the mixing separator in the form of droplets while building up a pressure loss, wherein a portion of the liquid cyclical process fluid entering at the second connection is evaporated depending on its temperature and superheating of the vaporous cyclical process fluid entering at the first connection is reduced.

In a further aspect, the present invention provides a drying device for drying a material to be dried via a heated process gas stream, wherein the drying device has a heat pump device as described above, so that the process gas stream can be heated as a heat sink on the heat-emitting side of the heat pump device.

This means that process heat can be utilized at a high temperature level of up to 250 °C to heat a process gas stream of the drying device.

In an additional aspect, the present invention provides a method for operating a heat pump device for the energy-efficient generation of a process heat, in particular in a temperature range between 100 °C and 250 °C, via a previously described heat pump device, having the following steps:
heating a liquid cyclical process fluid by indirect heat supply from a heat source and evaporating the liquid cyclical process fluid in an evaporator at a pressure stage of the evaporator;
compressing the vaporous cyclical process fluid to a second pressure stage via a first compressor;
feeding the compressed vaporous cyclical process fluid in at least one mixing separator of a second pressure stage;
feeding the vaporous cyclical process fluid emerging from the at least one mixing separator into at least one second compressor and compressing the vaporous cyclical process fluid from the second pressure stage to a first pressure stage;
transferring a process heat from the compressed, vaporous cyclical process fluid of the first pressure stage to at least one assignable heat sink; and
optionally feeding the condensed cyclical process fluid of the first pressure stage back into the at least one mixing separator.

In an embodiment of the method of the present invention, water, an alcohol and/or a water-soluble organic substance is or are used as the cyclical process fluid.

The heat pump device can, for example, be operated with water (chemical formula H₂O) as a natural and completely environmentally friendly cyclical process fluid. The heat pump device can also be operated with an alcohol and/or an aqueous solution of an alcohol as the cyclical process fluid. An aqueous solution of a water-soluble organic substance and/or one or more organic substances can also be used as a cyclical process fluid. Any combination of water, alcohol and/or water-soluble organic substance can also be used as a cyclical process fluid.

Methanol, ethanol or propanol can, for example, be used as the alcohol and an ester and/or an ether can be used as the organic substance.

In a further embodiment of the method of the present invention, a pressure increase can be carried out via a condensate pump in a stream of the condensed cyclical process fluid emerging from the at least one mixing separator, in particular a pressure stage higher than the pressure stage of the evaporator; this stream can then be mixed with a stream of liquid cyclical process fluid, which was previously indirectly heated in a heat exchanger of a heat source, and the mixed streams can be used for indirect heating of the evaporator before, in particular, the mixed stream is returned to the evaporator.

In a further embodiment of the method of the present invention, a pressure increase is carried out in a stream of the condensed cyclical process fluid emerging from the at least one mixing separator via at least one condensate pump, this stream is then introduced into vaporous cyclical process fluid from the at least one mixing separator to generate cyclical process fluid wet vapor, before the cyclical process fluid wet vapor is compressed to the first pressure stage in the downstream compressor.

The present invention is explained in greater detail below with reference to exemplary embodiments as shown in the drawings.

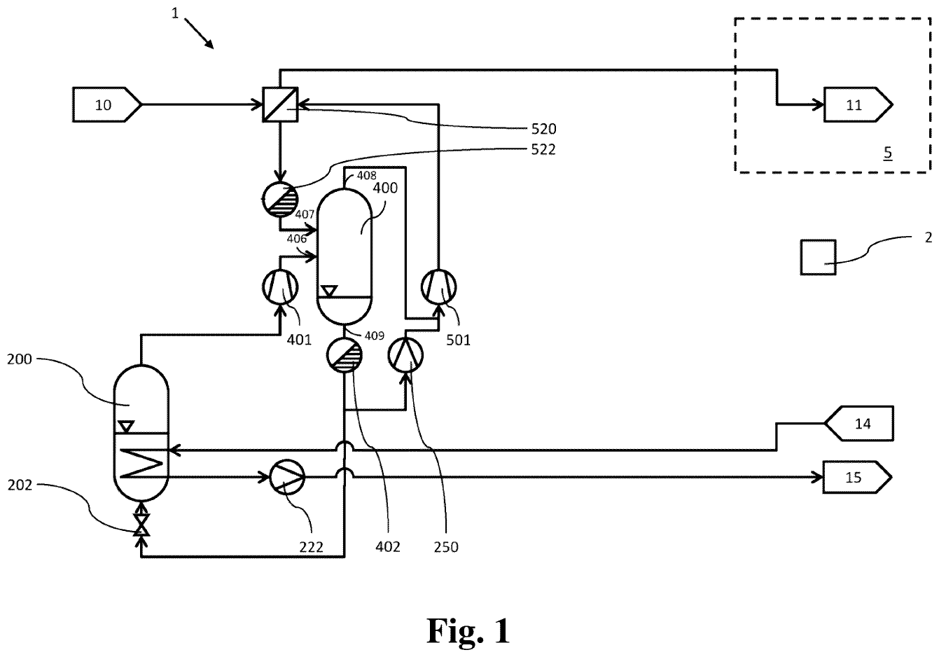

A heat pump device 1 shown in FIG. 1 has an evaporator 200 with heating via an inlet 14 and an outlet 15 of a heat source, a compressor 401 from the pressure stage of the evaporator 200 to a second pressure stage, a mixing separator 400 of a second pressure stage, a compressor 501 from a second to a first pressure stage, a heat exchanger 520 of a first heat sink for transferring process heat of a first pressure stage and an inlet 10 and an outlet 11 of a dryer device 5 as a heat sink. The heat pump device 1 has a control and regulating unit 2 for controlling and regulating the functions and components of the heat pump device 1.

The mixing separator 400 of the second pressure stage has a connection 406 for the inlet of vaporous cyclical process fluid, a connection 407 for the inlet of liquid cyclical process fluid, a connection 408 for the outlet 408 of vaporous cyclical process fluid, and a connection 409 for the outlet of liquid cyclical process fluid. A spraying device for spraying the liquid cyclical process fluid is integrated in the connection 407 for the inlet of liquid cyclical process fluid, in order to spray the incoming liquid cyclical process fluid into the mixing separator 400 in the form of droplets while building up a pressure loss, wherein a portion of the liquid cyclical process fluid entering at the connection 407 evaporates depending on its temperature, thereby reducing superheating of the vaporous cyclical process fluid entering at the connection 406.

At the lowest pressure of the cyclical process in the evaporator 200, usually a partial vacuum below atmospheric pressure, and at the same time at the lowest temperatures of the cyclical process, liquid cyclical process fluid returned from a mixing separator 400 of the second pressure stage is heated and vaporized by a heat source via inlet 14 and outlet 15 and then vaporous cyclical process fluid is compressed as dry vapor from the pressure stage of the evaporator in a compressor 401 to a second pressure stage and enters the mixing separator 400 of the second pressure stage superheated.

Vaporous cyclical process fluid emerges from the mixing separator 400 as dry vapor of a second pressure stage and is supersaturated with injected condensate and thus liquid cyclical process fluid via a condensate pump 250 prior to compression in a compressor 501 and thereby converted into wet vapor with a proportion of liquid cyclical process fluid, so that during the subsequent compression to a first pressure stage in the compressor 501, this liquid proportion evaporates and dry saturated vaporous cyclical process fluid of a first pressure stage emerges from the compressor 501. In a heat exchanger 520 of a heat sink, heat is transferred at the condensation temperature of a first pressure stage from the vaporous cyclical process fluid to the heat sink with an inlet 10 and an outlet 11, wherein the cyclical process fluid condenses. Liquid cyclical process fluid exits the heat exchanger 520 at approximately condensation temperature and at a first pressure stage via a condensate separator 522 and is introduced into the mixing separator 400 of the second pressure stage, wherein it expands to its second pressure stage and cools to its condensation temperature of the second pressure stage. In the process, part of the liquid cyclical process fluid introduced from the heat exchanger 520 evaporates and forms vaporous cyclical process fluid on the second pressure stage. A further liquid portion of the cyclical process fluid fed from the heat exchanger 520 vaporizes due to the degree of superheating of the superheated vaporous cyclical process fluid entering the mixing separator 400 from the compressor 401. The remaining liquid portion of the cyclical process fluid introduced into the mixing separator 400 from the heat exchanger 520 is considered excess liquid cyclical process fluid and exits the mixing separator 400 at the pressure and condensation temperature of the second pressure stage before being reintroduced into the evaporator 200.

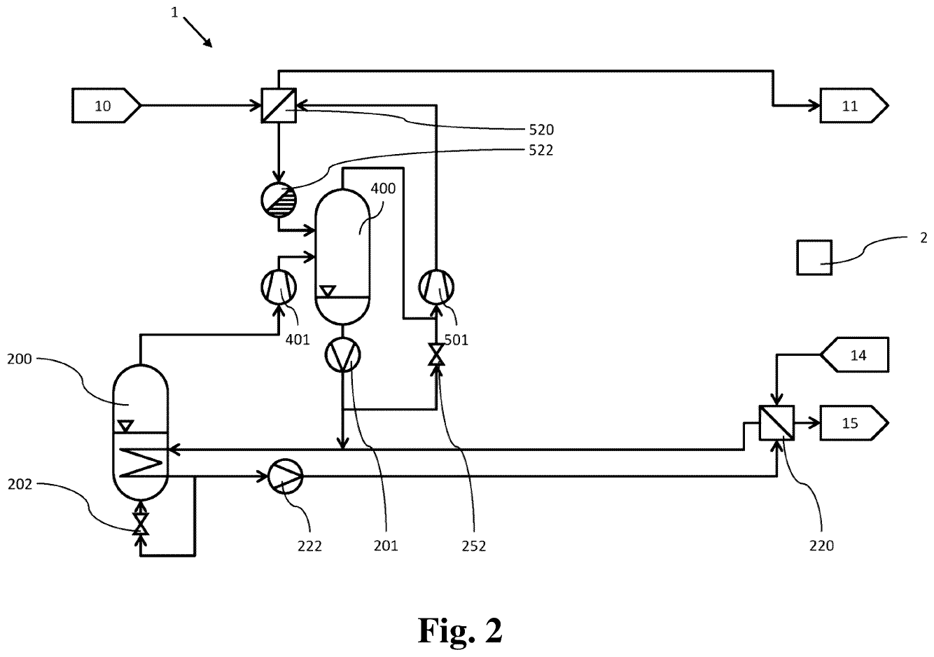

In an alternative shown in FIG. 2, a heat pump device 1 has indirect heating of the evaporator 200 via a circuit through a heat exchanger 220 of a heat source (14, 15), wherein, in contrast to the representation in FIG. 1, a flow of condensed cyclical process fluid from a mixing separator 400 of a second pressure stage is introduced into a flow of liquid cyclical process fluid, which was previously indirectly heated in the heat exchanger 220 of the heat source, and the mixture of both flows is used for indirect heating of an evaporator 200. A condensate pump 201 is used to overcome a pressure difference from the outlet of the second pressure stage to the circuit with a circulation pump 222.

In contrast to the embodiment in FIG. 1, the heat pump device 1 shown in FIG. 2 is also designed to introduce a cyclical process fluid condensed on a second pressure stage from a mixing separator 400 of a second pressure stage into vaporous cyclical process fluid from a second pressure stage to generate cyclical process fluid wet vapor before this wet vapor is compressed in a compressor 501 to a first pressure stage. A condensate pump 201 delivers the amount of condensed cyclical process fluid that emerges from the mixing condenser 400 of the next higher pressure stage above the pressure stage of the evaporator 200. At the same time, a condensate pump 201 provides sufficient injection pressure of liquid cyclical process fluid of a second pressure stage prior to compression 501 to a first pressure stage. The heat pump device 1 shown in FIG. 2 is otherwise operated as described above.

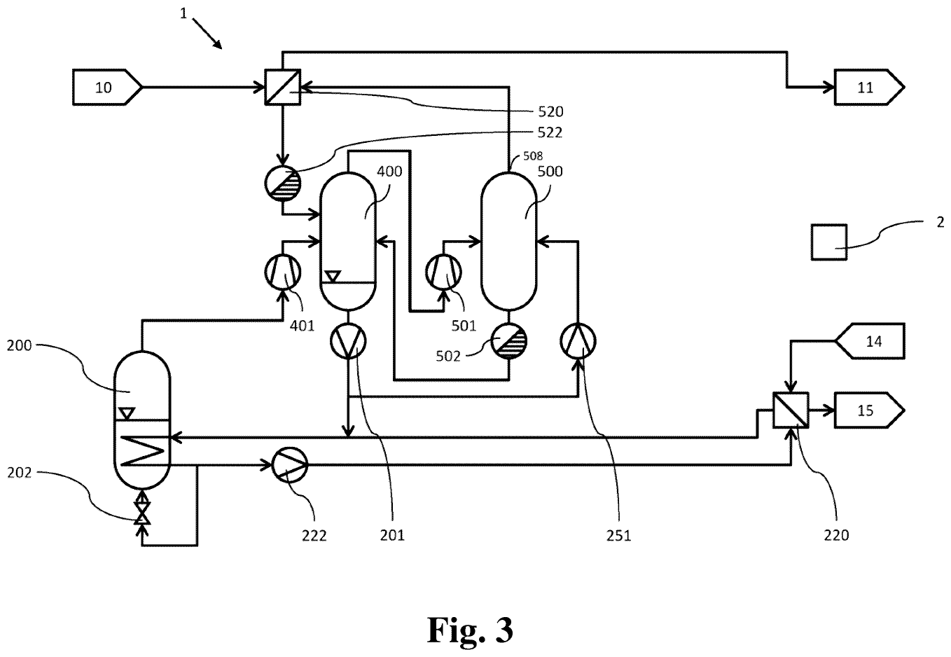

In contrast to the representation in FIG. 2, an alternative of a heat pump device 1 shown in FIG. 3 has the feature that vaporous cyclical process fluid after compression 501 from a second pressure stage to a first pressure stage and condensed cyclical process fluid of a second pressure stage are simultaneously introduced into a mixing separator 500 of a first pressure stage, in order to reduce superheating of the vaporous cyclical process fluid during compression without prior injection of liquid cyclical process fluid and to provide saturated vapor at a first pressure stage at the outlet 508 from the mixing separator 500.

In a minimal embodiment of the heat pump device 1 with at least three pressure stages according to FIG. 1, FIG. 2 or FIG. 3 and the use of, for example, water as cyclical process fluid, the evaporator 200 can be operated using waste heat at temperatures of, for example, 60-80 °C at an evaporation temperature of, for example, 54 °C, which corresponds to an evaporation pressure of the cyclical process fluid of 150 hPa. This evaporation pressure defines the operating conditions of a heat-absorbing side of the cyclical process and corresponds to the lowest condensation pressure of the cyclical process fluid within the cyclical process, which also corresponds to the lowest pressure stage of the heat pump device 1.

Starting from this lowest pressure stage in the evaporator 200, the vaporous cyclical process fluid, for example, water, is compressed to a second pressure stage in at least one compressor 401. The pressure of the second pressure stage depends on the achievable compression ratio of the selected compressor 401 which can, for example, be in a range of 1.2-6.0. Depending on the compressor design, the vaporous cyclical process fluid is heated to varying degrees during compression.

Based on an evaporation pressure of the cyclical process fluid in the evaporator 200 of 150 hPa and a compression ratio in the compressor 401 of, for example, 3.0, the pressure of the second pressure stage would be calculated to be 450 hPa. For the cyclical process fluid water, the boiling and condensation temperature of the second pressure stage corresponding to 450 hPa would be 78.7 °C.

If these two pressure stages (150 hPa; 54.0 °C) and (450 hPa; 78.7 °C) are compared, for example, with an isentropic compression with n=κ=1.333 from one evaporator pressure stage (150 hPa; 54.0 °C) to a second pressure stage with 450 hPa, which corresponds to a compression ratio of 3.0, then the temperature after isentropic compression would be T_{V2}=157.4 °C, which represents a superheating of T_{V2}−T_{D2}=157.4 °C=78.7 °C=78.7K compared to the corresponding condensation temperature of the second pressure stage of T_{D2} 78.7 °C.

This positive temperature difference of 78.7K makes it possible to transfer heat from a vapor compressed to a pressure level pᵥ₂ and thus superheated to such a liquid cyclical process fluid whose temperature corresponds at most to the corresponding boiling temperature TD₂ of the pressure level p_{D2}.

This circumstance is used to transfer the superheat enthalpy resulting from the compression to a pressure stage for the vaporization of liquid cyclical process fluid of the same pressure stage and thus to generate a higher proportion of vaporous cyclical process fluid at this pressure stage without this additional vaporous proportion having to be compressed to this pressure stage by performing mechanical work, i.e., the destruction of exergy.

This is achieved by the vaporous cyclical process fluid compressed to a second pressure stage in a compressor 401 entering the mixing separator 400 of the second pressure stage at a connection 406 for the inlet of vaporous cyclical process fluid, where it is brought into direct contact with liquid cyclical process fluid of the second pressure stage, which is located in the mixing separator 400 of the second pressure stage.

Within the mixing separator 400 of the second pressure stage, a quasi-stationary equilibrium is formed due to the direct contact of vaporous and liquid cyclical process fluid and due to rapidly occurring heat and mass transfer processes by simultaneous condensation of vaporous and evaporation of liquid cyclical process fluid, which is supported, for example, by a cyclone effect in order to separate vaporous cyclical process fluid from liquid cyclical process fluid and at the same time to allow it to emerge separately from the mixing separator 400 of the second pressure stage at separate connections 408, 409, in particular vaporous cyclical process fluid at at least port 408 and liquid cyclical process fluid at at least the connection 409.

The vaporous cyclical process fluid that exits at at least one connection 408 of the mixing separator 400 of the second pressure stage is then compressed in at least one compressor 501 from the second to a first pressure stage, wherein vaporous cyclical process fluid of this first pressure stage passes through the heat-emitting side of the heat pump device 1 and indirectly transfers process heat to at least one heat sink (10, 11) in a heat exchanger 520 and condenses in the process.

The process heat of the heat pump device 1 is therefore transferred at least by condensation of the vaporous cyclical process fluid at the condensation pressure of the first pressure stage and the corresponding condensation temperature. The pressure of the first pressure stage depends on the achievable compression ratio of the selected compressor 501, which can be in a range of, for example, 1.2-6.0.

Based on a second pressure stage pressure of 450 hPa and a compression ratio in the compressor 501 of, for example, 4.0, the pressure of the second pressure stage is then 1,800 hPa. For the cyclical process fluid water, the boiling and condensation temperature of the second pressure stage corresponding to 1,800 hPa is therefore 116.9 °C.

During the transfer of process heat on the heat-emitting side of the heat pump device 1, vaporous cyclical process fluid of the first pressure stage condenses at 116.9 °C in at least one heat exchanger 520 of the heat sink (10, 11), wherein condensed cyclical process fluid of the first pressure stage exits the heat exchanger 520 at a temperature that is not substantially below the corresponding condensation temperature of the first pressure stage and enters a mixing separator 400 of a second pressure stage at at least one connection 407, wherein the corresponding boiling and condensation temperature of the second pressure stage of approximately 78.7 °C is significantly below the corresponding boiling and condensation temperature of the first pressure stage of approximately 116.9 °C.

Due to this temperature difference when the condensed cyclical process fluid of the first pressure stage enters the mixing separator 400 of the second pressure stage, the pressure of which is lower than the pressure of the first pressure stage by the reciprocal of the compression ratio of the compressor 501 as described, spontaneous vaporization of a further proportion of liquid cyclical process fluid can occur.

With such spontaneous evaporation, the excess enthalpy of the liquid cyclical process fluid entering at a higher temperature can be utilized as the enthalpy of evaporation until it cools down to the corresponding boiling and condensation temperature of the second pressure stage. With the described temperature difference of 116.9 °C−78.7 °C=38.2K and an assumed specific heat capacity of 4.186 kJ/kg·K of the liquid cyclical process fluid, a specific enthalpy of vaporization of around 2,313 kJ/kg is required for isobaric vaporization at the pressure of the second pressure stage of 450 hPa. In relation to the mass flow rate of the liquid cyclical process fluid entering from the condensed cyclical process fluid of the first pressure stage at the connection 407 for entry into the mixing separator 400 of the second pressure stage, the ratio of the specific enthalpies results in a mass ratio of (4.186 kJ/kg·K−38.2K)/(2,313 kJ/kg)=0.069 kg/kg of additional vaporized cyclical process fluid, without this additional vaporous portion having to be compressed in a preceding compression stage, such as in a compressor 401, by applying mechanical work to the second pressure stage.

The portion of liquid cyclical process fluid that enters the mixing separator 400 of the second pressure stage at a connection 407 and is not evaporated to reduce superheating or by spontaneous evaporation is referred to as the excess portion of liquid cyclical process fluid of the second pressure stage and exits the mixing separator 400 at at least the connection 409, from where at least a portion is passed on directly or indirectly to the evaporator 200.

The previously described minimum configuration of a heat pump device 1 according to FIGS. 1 to 3 with the cyclical process fluid water will be described below with regard to the achievable heating coefficient of performance COPₕ and thus the achievable energy efficiency.

The specific condensation enthalpy corresponding to the first pressure stage (1,800 hPa; 116.9 °C) is 2,213 kJ/kg as a measure of the process heat that can be transferred to a heat sink (10, 11) at the corresponding condensation temperature of 116.9 °C on the heat-emitting side of the heat pump device 1. For a process heat transfer of 1 MW power, a mass flow of cyclical process fluid of the first pressure stage condensing in the heat exchanger 520 of 1,628 kg/h is therefore required, which then enters the mixing separator 400 of the second pressure stage as liquid cyclical process fluid at approximately 116.9 °C at a connection 407.

To deliver 1,628 kg/h of vaporous cyclical process fluid of the first pressure stage, compression is required via the compressor 501 from a second pressure stage (450 hPa; 78.7 °C) to the first pressure stage (1,800 hPa; 116.9 °C). A distinction can in principle be made between dry compaction and wet vapor compaction. In the case of wet vapor compression as shown in FIG. 1 or FIG. 2, the outgoing mass flow already corresponds to the required delivery mass flow of 1,628 kg/h of vaporous cyclical process fluid of the first pressure stage, as exactly enough liquid cyclical process fluid is sprayed at the inlet of the compressor 501 to reduce the superheating that occurs during compression. In the case of dry compression, the superheating of the compression in the subsequent mixing separator 500 of the first pressure stage according to FIG. 3 would have to be reduced by spraying around 138 kg/h of liquid cyclical process fluid from the mixing separator 400 of the second pressure stage into the mixing separator 500 of the first pressure stage and evaporating it due to the superheating of the dry compressed vapor in the compressor 501. This 138 kg/h of liquid cyclical process fluid therefore does not need to be compressed in the compressor 501 by applying mechanical work to the first pressure stage. This means that the mass flow through the compressor 501 only needs to be 1,628 kg/h−138 kg/h=1,490 kg/h. The electrical power consumption of the compressor 501 is around 131.6 kW.

These 1,490 kg/h to be compressed in the compressor 501 emerge from the connection 408 of the mixing separator 400 of the second pressure stage. The 1,628 kg/h of liquid cyclical process fluid of the first pressure stage condensed in the heat exchanger 520 enters via the connection 407 of the mixing separator 400, of which around 0.069 kg/kg evaporates by spontaneous evaporation, meaning that around 112 kg/h of vaporous cyclical process fluid of the second pressure stage is formed by spontaneous evaporation. Of the remaining approximately 1,516 kg/h of liquid cyclical process fluid in the mixing separator 400, around 87 kg/h is required to reduce the superheating from the compression to the second pressure stage, so that the mass flow of vaporous cyclical process fluid in the compressor 401 must be around 1,490 kg/h−112 kg/h−87 kg/h=1,291 kg/h. The electrical power consumption of the compressor 401 is around 81.5 kW.

This 1,291 kg/h of vaporous cyclical process fluid to be compressed in the compressor 401 emerges from the evaporator 200 and is evaporated there beforehand at the pressure stage (150 hPa; 54.0 °C) of the evaporator 200 via indirect heating with an output of around 848 kW. This heat output is made up of around 34 kW of heat recovery from the liquid cyclical process fluid leaving the mixing separator 400 at connection 409 and around 811 kW of waste heat from a heat source (14, 15).

In the alternative of the heat pump device 1 in a minimal configuration with only a few main components as shown in FIG. 3, a total electrical power consumption of around 131.6 kW+81.5 kW+1.9 kW=215 kW is used for the compression of vaporous cyclical process fluid in the compressors (401, 501) and for various pumps (201, 222, 251) for liquid cyclical process fluid to supply 1,000 kW of process heat. This means that the heating coefficient of performance COPₕ=4.65 with a temperature rise of 116.9 °C−60 °C=56.9 K.

A compression shown in FIGS. 1 to 11 via the corresponding compressors 301, 311, 401, 501, 601 within the respective alternative of the heat pump device 1 according to the present invention generalizes that compression via the corresponding compressors 301, 311, 401, 501, 601 of vaporous cyclical process fluid takes place by performing mechanical work either in a compressor in the design of a turbomachine, such as an axial blower, a centrifugal blower, a turbo compressor or a turbine, or that compression of vaporous cyclical process fluid takes place by performing mechanical work in a compressor in the design of a positive displacement machine, such as a piston compressor, a rotary piston compressor or a screw compressor.

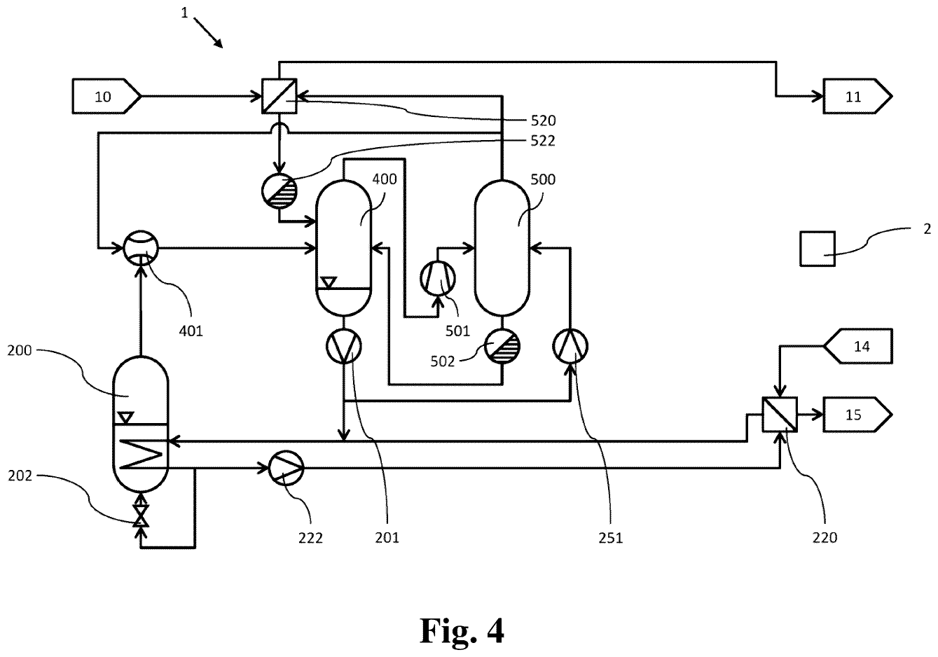

In contrast to FIG. 3, an alternative heat pump device 1 shown in FIG. 4 has the feature that compression takes place via a compressor 401 of vaporous cyclical process fluid in a thermal compressor, such as a vacuum vapor jet pump, in which vaporous cyclical process fluid of a first pressure stage is used as motive steam, which reaches high velocities by thermal compression and thereby, due to Venturi or Coandă effects, draws in a suction vapor in the form of vaporous cyclical process fluid at a pressure lower than that of the motive steam, wherein motive steam and suction vapor then mix to form a mixed vapor with the pressure of a second pressure stage, which has a higher pressure than the suction vapor and a lower pressure than the motive steam.

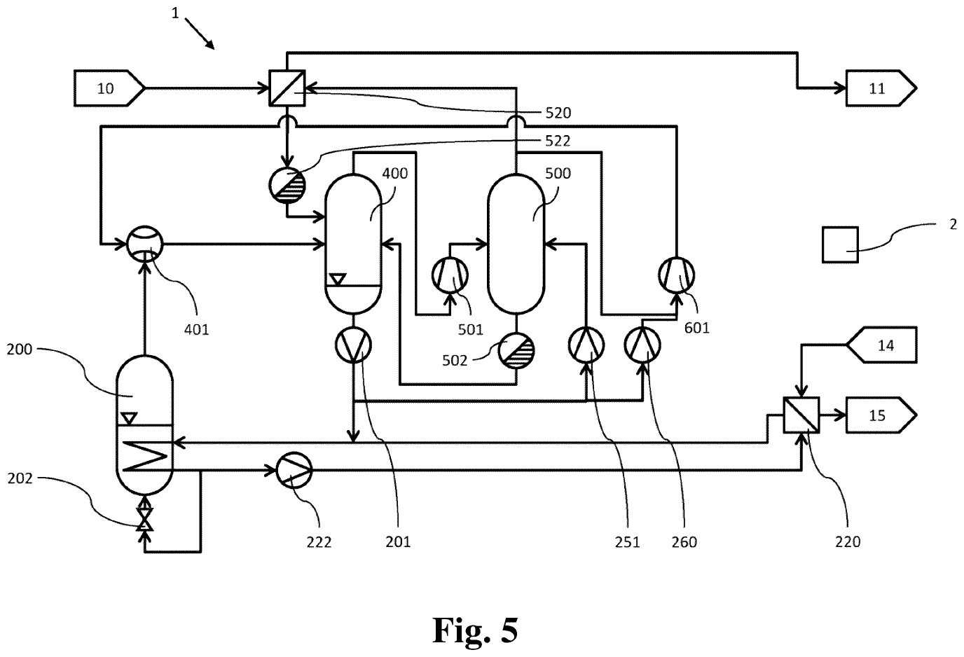

In contrast to FIG. 4, an alternative heat pump device 1 shown in FIG. 5 has the feature that vaporous cyclical process fluid from a first pressure stage is further compressed in a compressor 601 and this compressed vaporous cyclical process fluid is used as motive steam that reaches high velocities in a thermal compression process and thereby, due to Venturi or Coandă effects, draws in a suction vapor in the form of vaporous cyclical process fluid at a pressure lower than that of the motive steam, wherein motive steam and suction vapor then mix to form a mixed vapor with the pressure of a second pressure stage, which has a higher pressure than the suction vapor and a lower pressure than the motive steam. FIG. 5 also shows that a cyclical process fluid condensed on the second pressure stage is introduced from the mixing separator 400 of a second pressure stage into vaporous cyclical process fluid from a first pressure stage to generate cyclical process fluid wet vapor before this wet vapor is compressed in the compressor 601 to a motive vapor pressure stage. At the same time, a condensate pump 260 provides a sufficient injection pressure of liquid cyclical process fluid of a second pressure stage before compression via the compressor 601 to a motive steam pressure stage.

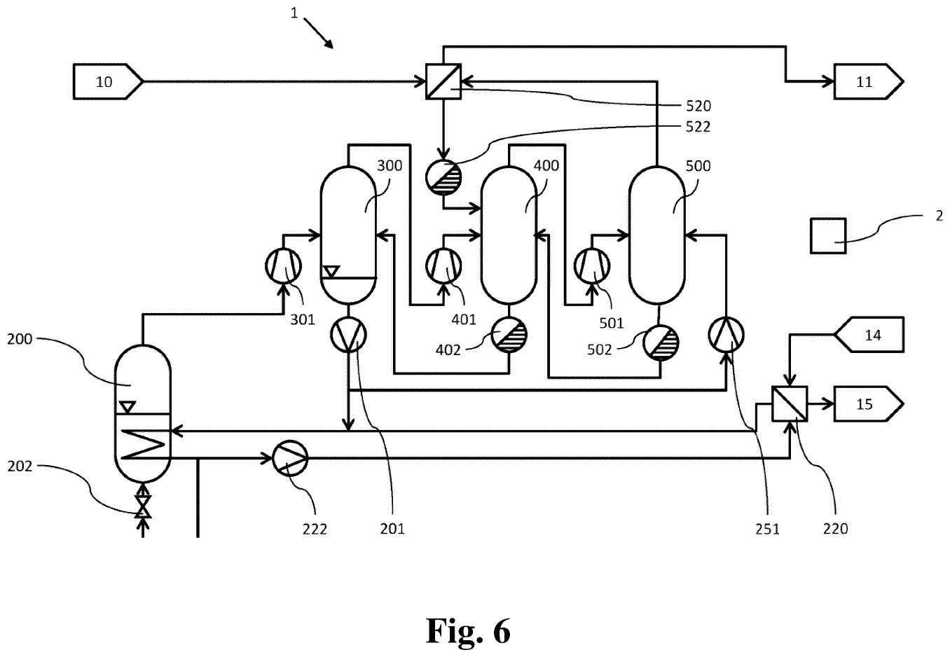

In contrast to FIG. 3, an alternative of the heat pump device 1 shown in FIG. 6 has the feature that a further third pressure stage having a mixing separator 300 and a compressor 301 has been added and liquid cyclical process fluid from a mixing separator (400, 500) of a second or first pressure stage is introduced into the further mixing separator (300, 400) of a second pressure stage, the pressure and temperature of which are lower than the pressure and temperature of the liquid cyclical process fluid introduced. A condensate pump 201 conveys the amount of condensed cyclical process fluid that, in this case and in contrast to the illustration in FIGS. 1 to 5, emerges from the mixing condenser 300 of the next higher pressure stage above the pressure stage of the evaporator 200. At the same time, compression from a low to a second pressure stage can take place either in the compressor 301 in the design of a turbomachine or positive displacement machine, or in the design of a thermal compressor, as shown in FIG. 4 or FIG. 5.

In another alternative of a heat pump device 1, the coefficient of performance can be increased by increasing the number of pressure stages to, for example, at least 4 pressure stages as shown in FIG. 6 for the same temperature rise. If, for example, instead of a first pressure stage (1,800 hPa; 116.9 °C), a second pressure stage (450 hPa; 78.7 °C) and a pressure stage of the evaporator 200 (150 hPa; 54.0 °C) similar to the illustrations in FIGS. 1 to 3, the gradation is reduced to, for example, a first pressure stage (1,800 hPa; 116.9 °C), a second pressure stage (450 hPa; 78.7 °C), a third pressure stage (225 hPa; 62.6 °C) and a pressure stage of the evaporator 200 (150 hPa; 54.0 °C), this results in a heating coefficient of performance COPₕ=4.71 with a temperature rise of 116.9 °C−60 °C=56.9 K, as more exergy can be recovered overall from the condensed cyclical process fluid of higher stages due to smaller differences between the pressures of the pressure stages.

In another alternative of a heat pump device 1, the temperature rise can be increased by increasing the compression ratios of individual compressors (301, 401, 501) while maintaining the same number of pressure stages, as shown, for example, in FIG. 6. If, for example, a first pressure stage (4,044 hPa; 144.0 °C), a second pressure stage (674 hPa; 88.9 °C), a third pressure stage (225 hPa; 62.6 °C) and a pressure stage of the evaporator 200 (150 hPa; 54.0 °C) are configured, which results in a heating coefficient of performance COPₕ=3.44 with a temperature rise of 144.0 °C−60 °C=84.0K.

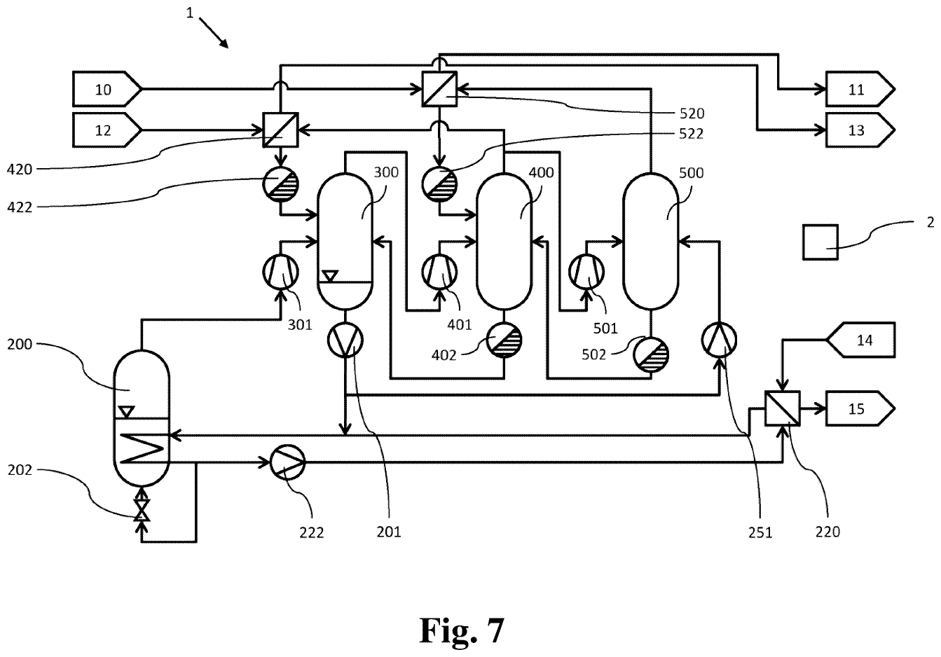

In another alternative of a heat pump device 1, the coefficient of performance can be increased by splitting the transfer of process heat to a first and a second heat sink with different lowering temperatures as shown in FIG. 7 for the same temperature rise and the same number of pressure stages, for example, at least four pressure stages as shown in FIG. 6. If all process heat is transferred at a uniform sink temperature as shown in FIG. 6, a heating coefficient of performance COPₕ=3.44 can be achieved with a temperature rise of, for example, 84.0K.

If the process heat is divided according to another alternative of the heat pump device 1 as shown in FIG. 7 in such a way that approximately half is transferred at a first pressure stage and the other half at a second pressure stage via the heat exchangers 420, 520, a heating coefficient of performance of COPₕ=4.35 can be achieved without having to reduce the maximum temperature rise of, for example, 84.0K.

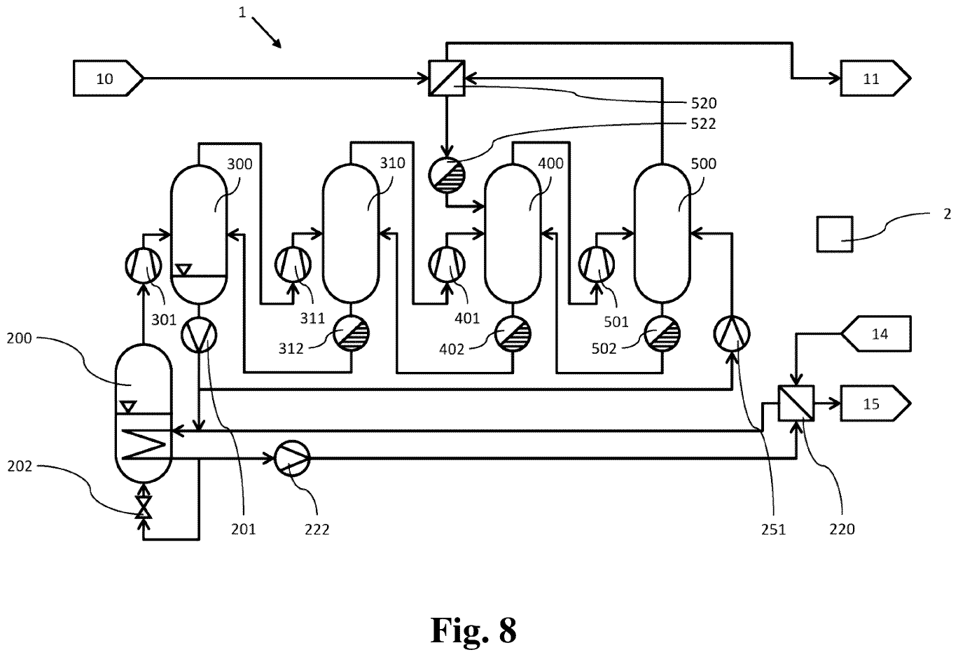

In contrast to the representation in FIG. 6, an alternative of the heat pump device 1 shown in FIG. 8 has the feature that a further pressure stage with a mixing separator 310, a compressor 311 and a condensate separator 312 has been added as a third pressure stage, whereby the third pressure stage from FIG. 6 has become a fourth pressure stage, and liquid cyclical process fluid from a mixing separator 400 of a second pressure stage is introduced into the mixing separator 310 associated with the third pressure stage, the pressure and temperature of which are lower than the pressure and temperature of the introduced liquid cyclical process fluid of the pressure stage above.

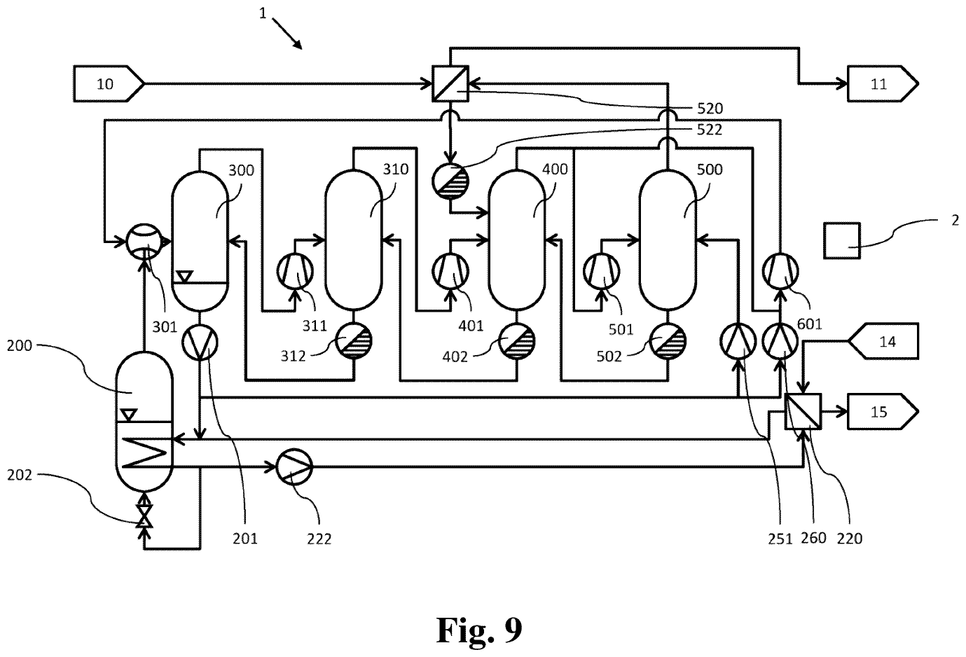

In contrast to the illustration in FIG. 8, an alternative of the heat pump device shown in FIG. 9 has the feature that compression from one pressure stage of the evaporator 200 to a fourth pressure stage in a compressor 301 can also take place in the design of a thermal compressor, as shown analogously to the illustration in FIG. 4 or FIG. 5 and also applies analogously to compression processes between other pressure stages.

Based on the analogies shown in FIGS. 1 to 9, it is clear that a heat pump device 1 according to the present invention can in principle be variable with regard to the number of pressure stages built up, including the required components and devices per pressure stage, as well as with regard to the selection of the design of compressors. Starting from a second pressure stage, vaporous cyclical process fluid can, for example, also be compressed into motive steam via a compressor 601, as shown in FIG. 9, by taking vaporous cyclical process fluid from a mixing separator 400 of a second pressure stage and compressing it as motive steam in a compressor 601 for the operation of a vapor jet vacuum pump, with which vaporous cyclical process fluid of any lower pressure stage or, as shown in FIG. 9, from the evaporator 200 is compressed to a fourth pressure stage.

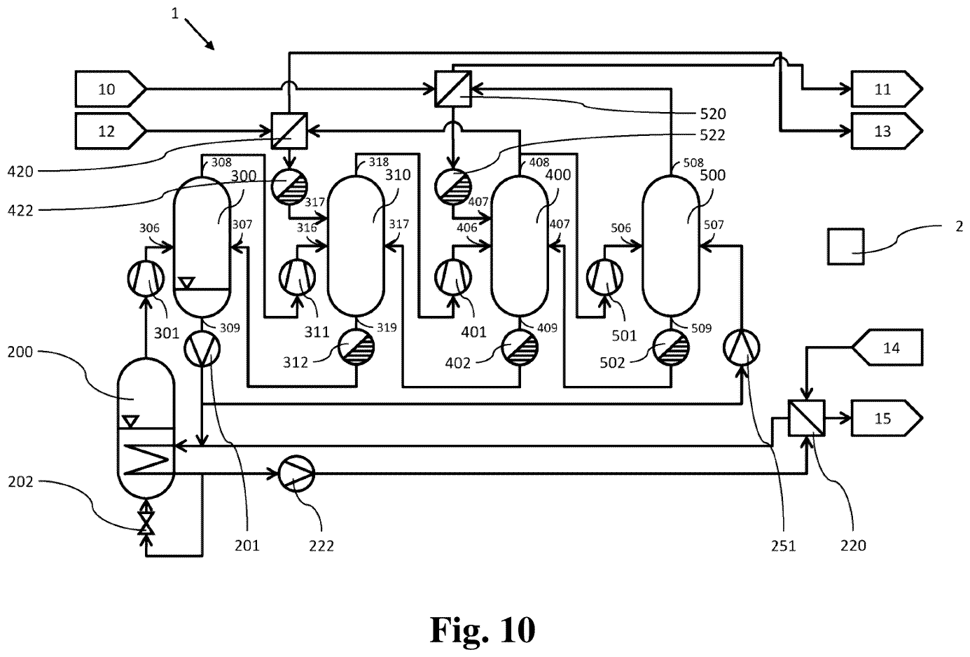

In contrast to the illustration in FIG. 8, an alternative of the heat pump device 1 shown in FIG. 10 has vaporous cyclical process fluid of a second pressure stage condensing in at least one heat exchanger 420 of a heat sink with at least one inlet 12 and at least one outlet 13 and indirectly transferring heat thereto, wherein a cyclical process fluid condensed at a second pressure stage in the heat exchanger 420 of the heat sink enters a mixing separator 310 of a third pressure stage at a pressure below that of the cyclical process fluid condensing in the heat exchanger 420 via at least one connection 317.

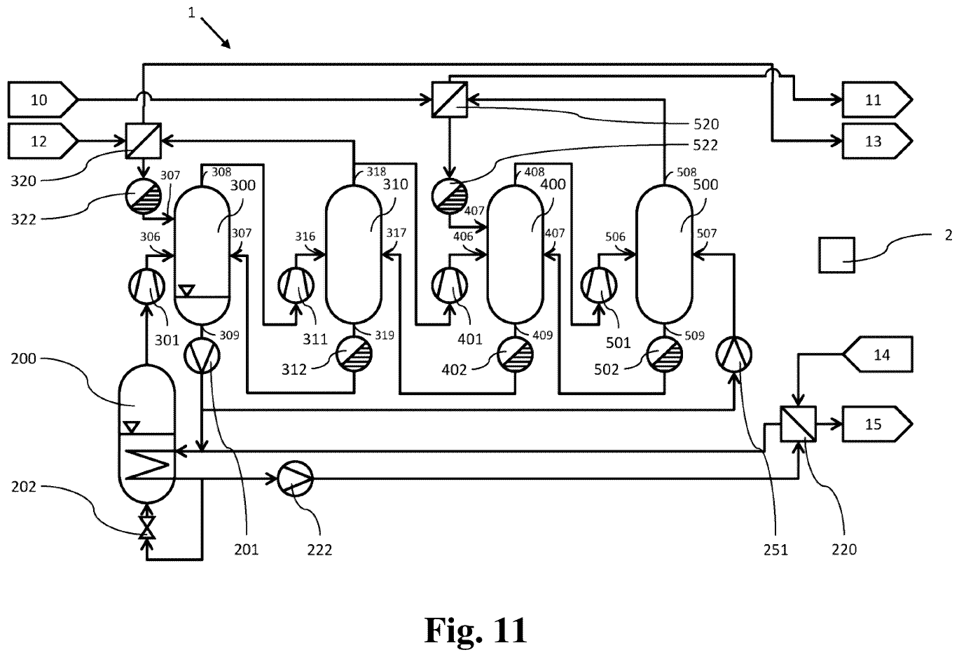

In contrast to the representation in FIG. 10, an alternative of the heat pump device 1 shown in FIG. 11 has the feature that vaporous cyclical process fluid of a third pressure stage condenses in at least one heat exchanger 420 of a heat sink with at least one inlet 12 and at least one outlet 13 and indirectly transfers heat thereto, wherein a cyclical process fluid condensed at a third pressure stage in the heat exchanger of a heat sink enters a mixing separator 300 of a fourth pressure stage at a pressure below the pressure of the cyclical process fluid condensing in the heat exchanger 420 via at least one connection 307.

Based on the illustrations in FIGS. 10 and 11, it is shown that at least a second temperature level for further process heat transfer to at least one further heat sink is provided at the level of the condensation temperature of a second or third pressure stage in at least one heat exchanger 420 of a heat sink with at least one inlet 12 and at least one outlet 13. This provides that a process heat transfer at at least a second temperature level already enables a process heat supply up to a temperature close to the condensation temperature of that second or third pressure stage, wherein up to that point only the mechanical work for compression up to that second or third pressure stage must be expended.

For a remaining process heat transfer up to a temperature close to the condensation temperature of a first pressure stage, only the difference in mechanical work for compression from the second or third pressure stage already reached up to that first pressure stage would then have to be expended, but with a significantly lower specific process heat requirement and less specific mechanical work for compression. By staging the provision of process heat in this way, the specific exergy destruction in relation to the total process heat transferred can also be favorably reduced, which further increases the overall heating coefficient of performance.

In an alternative (not shown) of a heat pump device 1 with a further subdivision into at least 7 pressure stages, i.e., a first pressure stage (15,550 hPa; 200.0 °C), a second (3,390 hPa; 142.6 °C), a third (1,300 hPa; 107.0 °C), a fourth (441 hPa; 78.2 °C), a fifth (260 hPa; 65.8 °C), a sixth (180 hPa; 57.7 °C) and a pressure stage of the evaporator 200 (150 hPa; 54.0 °C), a heating coefficient of performance COPₕ=2.48 can be achieved over a temperature rise of 200.0 °C−60 °C=140.0K. Here, too, the coefficient of performance can be increased by splitting the transfer of process heat with the same temperature rise and the same number of pressure stages. If the heat is split so that around half of the process heat is provided at the first pressure level (15,550 hPa; 200.0 °C) and the other half at the third pressure level (1,300 hPa; 107.0 °C), the heating coefficient of performance increases by around +40% to over COPₕ=3.40.

By definition, providing process heat requires an electrical power consumption equal to the product of the process heat and the reciprocal of the heating coefficient of performance. This means that with a heat pump device 1, only an electrical power consumption of less than 0.3 kWel/kW process heat is required to provide process heat at a temperature level of 200 °C, for example, which equates to a saving of over 70% primary energy input and 100% reduction in fossil process heat generation via the heat pump device 1.

The heat pump devices 1 have a high energy efficiency and are flexible, modularly expandable and adaptable to a wide range of requirements with regard to required sink temperatures and/or other parameters.

The present invention is not limited to embodiments described herein; reference should be had to the appended claims.

LIST OF REFERENCE NUMERALS

| | |
|---|---|
| 1 | Heat pump device |
| 2 | Control and regulating unit |
| 5 | Dryer device |
| 10 | Inlet of a first heat sink |
| 11 | Outlet of a first heat sink |
| 12 | Inlet of a second heat sink |
| 13 | Outlet of a second heat sink |
| 14 | Inlet of a heat source |
| 15 | Outlet of a heat source |
| 200 | Evaporator |
| 201 | Condensate pump |
| 202 | Control valve |
| 220 | Heat exchanger of a heat source |
| 222 | Circulation pump |
| 250 | Condensate pump for spraying in front of a compressor |
| 251 | Condensate pump for spraying in a mixing separator |
| 252 | Control valve |
| 260 | Condensate pump for spraying in front |
| | of a motive steam compressor |
| 300 | Mixing separator of a third pressure stage |
| 301 | Compressor to the pressure of a third pressure stage |
| 306 | Connection for the inlet of vaporous cyclical process fluid |
| 307 | Connection for the inlet of condensed cyclical process fluid |
| 308 | Connection for the outlet of vaporous cyclical process fluid |
| 309 | Connection for the outlet of condensed cyclical process fluid |
| 310 | Mixing separator of a further pressure stage |
| 311 | Compressor to the pressure of a further pressure stage |
| 312 | Condensate separator of a further pressure stage |
| 316 | Connection for the inlet of vaporous cyclical process fluid |
| 317 | Connection for the inlet of condensed cyclical process fluid |
| 318 | Connection for the outlet of vaporous cyclical process fluid |
| 319 | Connection for the outlet of condensed cyclical process fluid |
| 320 | Heat exchanger of a heat sink of a third pressure stage |
| 322 | Condensate separator of a heat exchanger of a third pressure stage |
| 400 | Mixing separator of a second pressure stage |
| 401 | Compressor to the pressure of a second pressure stage |
| 402 | Condensate separator of a second pressure stage |
| 406 | Connection for the inlet of vaporous cyclical process fluid |
| 407 | Connection for the inlet of condensed cyclical process fluid |
| 408 | Connection for the outlet of vaporous cyclical process fluid |
| 409 | Connection for the outlet of condensed cyclical process fluid |
| 420 | Heat exchanger of a heat sink of a second pressure stage |
| 422 | Condensate separator of a heat exchanger |
| | of a second pressure stage |
| 500 | Mixing separator of a first pressure stage |
| 501 | Compressor to the pressure of a first pressure stage |
| 502 | Condensate separator of a first pressure stage |
| 506 | Connection for the inlet of vaporous cyclical process fluid |
| 507 | Connection for the inlet of condensed cyclical process fluid |
| 508 | Connection for the outlet of vaporous cyclical process fluid |
| 509 | Connection for the outlet of condensed cyclical process fluid |
| 520 | Heat exchanger of a heat sink of a first pressure stage |
| 522 | Condensate separator of a heat exchanger of a first pressure stage |
| 601 | Compressor for generating motive steam |

What is claimed is:

1-15. (canceled)

16. A heat pump device for an energy-efficient generation of a process heat, the heat pump device comprising:
a heat-absorbing side;
a heat-emitting side;
a liquid cyclical process fluid;
an evaporator arranged on the heat-absorbing side, the evaporator comprising a pressure stage;
at least one heat exchanger assigned to the heat-emitting side;
at least one heat sink assigned to the heat-emitting side;
at least one heat source assigned to the heat-absorbing side, wherein the evaporator is configured to indirectly heat the liquid cyclical process fluid via heat supplied from the at least one heat source which is assigned to the heat-absorbing side, and to evaporate the so heated liquid cyclical process fluid at the pressure stage of the evaporator to a vaporous cyclical process fluid;
at least one first compressor connected downstream of the evaporator, the at least one first compressor being configured to compress the vaporous cyclical process fluid from the pressure stage of the evaporator to a second pressure stage;
at least one first mixing separator in the second pressure stage, the at least one first mixing separator comprising,
a first connection for an inlet of the vaporous cyclical process fluid,
a second connection for an inlet of a condensed cyclical process fluid,
a third connection for an outlet of the vaporous cyclical process fluid, and
a fourth connection for an outlet of an emerging condensed cyclical process fluid; and
at least one second compressor connected downstream of the at least one first mixing separator, the at least one second compressor being configured to compress the vaporous cyclical process fluid emerging from the third connection from the second pressure stage to a first pressure stage,
wherein,
the at least one heat exchanger is configured to indirectly transfer the process heat from the vaporous cyclical process fluid of the first pressure stage to the at least one heat sink,
the at least one heat exchanger is configured to condense the vaporous cyclical process fluid to the condensed cyclical process fluid,
the second connection is configured and connected to feed back the condensed cyclical process fluid condensed in the at least one heat exchanger into the at least one first mixing separator of the second pressure stage,
the first connection is configured and connected to, simultaneously with the feeding back via the second connection of the condensed cyclical process fluid condensed in the at least one heat exchanger into the at least one first mixing separator of the second pressure stage, feed the vaporous cyclical process fluid from the at least one first compressor into the at least one first mixing separator, and
the fourth connection is configured and connected to feed back the emerging condensed cyclical process fluid directly or indirectly into the evaporator and/or to feed the emerging condensed cyclical process fluid to the at least second compressor.

17. The heat pump device as recited in claim 16, wherein,
the at least one heat exchanger is assigned to the first pressure stage, and/or
further comprising:
a second heat exchanger which is assigned to the second pressure stage, and/or
a third heat exchanger on the heat-emitting side which is assigned to a third pressure stage which is below the second pressure stage.

18. The heat pump device as recited in claim 17, further comprising:
a second mixing separator;
a third mixing separator;
a fourth mixing separator; and/or
a further mixing separator; and
each further respective compressor which being connected upstream of each of the second mixing separator, the third mixing separator, the fourth mixing separator, and/or the further mixing separator.

19. The heat pump device as recited in claim 18, wherein the second connection for the inlet of the condensed cyclical process fluid comprises a spraying device which is configured to spray the condensed cyclical process fluid entering the at least one first mixing separator, the second mixing separator, the third mixing separator, the fourth mixing separator, or the further mixing separator, respectively.

20. The heat pump device as recited in claim 18, wherein,
the second mixing separator, the third mixing separator, the fourth mixing separator, and/or the further mixing separator, or two or more of the second mixing separator, the third mixing separator, the fourth mixing separator, and/or the further mixing separator is or are connected upstream of the at least one first mixing separator,
the vaporous cyclical process fluid of the second mixing separator, the third mixing separator, the fourth mixing separator, and/or the further mixing separator, or of two or more of the second mixing separator, the third mixing separator, the fourth mixing separator, and/or the further mixing separator, which is or are connected upstream of the at least one first mixing separator, is arranged to be fed to a downstream mixing separator via a respective downstream compressor, and/or
the liquid cyclical process fluid from the respective downstream mixing separator is arranged to be fed back to an upstream mixing separator at a higher pressure and/or at a higher temperature than in the upstream mixing separator.

21. The heat pump device as recited in claim 20, further comprising:
a first condensate separator which is connected downstream of the at least one heat exchanger, and/or
a second condensate separator which is connected downstream of the second heat exchanger, and/or
a third condensate separator which is connected downstream of the further heat exchanger,
each for feeding the condensed cyclical process fluid from the first pressure stage back into the at least one first mixing separator and/or for feeding the condensed cyclical process fluid from the second pressure stage or from a third pressure stage back into an upstream mixing condenser.

22. The heat pump device as recited in claim 20, further comprising:
at least one condensate separator which is/are configured to feed the condensed cyclical process fluid back into the respective upstream mixing separator or into the evaporator, the at least one condensate separator being arranged downstream of the fourth connection for the outlet of the condensed cyclical process fluid from the at least one first mixing separator, the upstream mixing separator, and/or a respective mixing separator.

23. The heat pump device as recited in claim 16, further comprising:
a further mixing separator which is connected downstream of the at least one first mixing separator in the second pressure stage, the further mixing separator being arranged in the first pressure stage.

24. The heat pump device as recited in claim 16, further comprising:
a control and/or regulating device which is configured to control and/or regulate components of the heat pump device.

25. The heat pump device as recited in claim 24, wherein the control and/or regulating device is further configured to control and/or regulate the at least one heat source and/or the at least one heat sink.

26. A dryer device for drying a material to be dried via a heated process gas stream, the dryer device comprising:
the heat pump device as recited in claim 16,
wherein, the dryer device is configured so that a process gas stream is heated as a heat sink on the heat-emitting side of the heat pump device.

27. A method for operating a heat pump device for an energy-efficient generation of a process heat via the heat pump device as recited in claim 16, the method comprising:
heating a liquid cyclical process fluid via an indirect heat supply from the at least one heat source;
evaporating the liquid cyclical process fluid in the evaporator at the pressure stage of the evaporator to the vaporous cyclical process fluid;
compressing the vaporous cyclical process fluid to the second pressure stage via the at least one first compressor;
feeding the compressed vaporous cyclical process fluid to at least one mixing separator of the second pressure stage;
feeding the vaporous cyclical process fluid emerging from the at least one mixing separator into the at least one second compressor and compressing the vaporous cyclical process fluid from the second pressure stage to the first pressure stage; and
transferring a process heat from the compressed cyclical process fluid of the first pressure stage to the at least one heat sink.

28. The method as recited in claim 27, further comprising:
feeding the condensed cyclical process fluid of the first pressure stage back into the at least one mixing separator.

29. The method as recited in claim 27, wherein the process heat has a temperature range of from 100 °C and 250 °C.

30. The method as recited in claim 27, wherein water, an alcohol, and/or a water-soluble organic substance is used as the liquid cyclical process fluid.

31. The method as recited in claim 27, wherein the heat pump device further comprises a condensate pump, and
the method further comprises:
performing a pressure increase in a stream of the condensed cyclical process fluid emerging from the at least one mixing separator via the condensate pump;
mixing the stream with a stream of the liquid cyclical process fluid which was previously indirectly heated in a heat exchanger of the at least one heat source; and
using the mixed streams to indirectly heat the evaporator.

32. The method as recited in claim 27, wherein the heat pump device further comprises a condensate pump, and
the method further comprises:
performing a pressure increase in a stream of the condensed cyclical process fluid emerging from the at least one mixing separator via the condensate pump; and
introducing the stream into the vaporous cyclical process fluid from the at least one mixing separator to generate a cyclical process fluid wet vapor before the cyclical process fluid vapor wet is compressed to the first pressure stage via the downstream at least one second compressor.
